(19) United States
(12) Patent Application Publication
(10) Pub. No.: US 2019/0026950 A1
(43) Pub. Date: Jan. 24, 2019

(54) PROGRAM EXECUTED ON A COMPUTER FOR PROVIDING VIRTUAL SPACE, METHOD AND INFORMATION PROCESSING APPARATUS FOR EXECUTING THE PROGRAM

(71) Applicant: COLOPL, Inc., Tokyo (JP)

(72) Inventors: Kazuaki SAWAKI, Tokyo (JP); Takashi NAKABO, Tokyo (JP)

(21) Appl. No.: 16/040,543

(22) Filed: Jul. 20, 2018

(30) Foreign Application Priority Data
Jul. 21, 2017 (JP) 2017-141711

(51) Int. Cl. G06T 19/00; G06T 13/40; G06F 3/0481; G06F 3/0484

(52) U.S. Cl. CPC G06T 19/006; G06T 13/40; G06T 2219/024; G06F 3/0484; G06F 3/04815

(57) ABSTRACT

A method of providing a virtual space according to at least one embodiment of this disclosure includes defining a virtual space, wherein the virtual space comprises a first avatar object, the first avatar object is associated with a first user, and the first user is associated with a first head-mounted device. The method further includes determining a field of view of the first user based on a first virtual camera arranged in the virtual space. The method further includes displaying an image corresponding to the field of view of the first user on the first head-mounted device. The method further comprises arranging a first photography object in the virtual space, wherein the first photography object includes a user interface (UI) configured to receive from the first user a first operation of photographing in the virtual space. The method further includes identifying a photography range of the first photography object in response to receiving the first operation from the first user. The method further includes rendering an image corresponding to the identified photography range. The method further includes arranging, in response to the rendering, a first photograph object in the virtual space at a first position determined in advance, wherein the first photograph object comprises the rendered image. The method further includes arranging a first guide object in the field of view of the first user in response to the arranging of the first photograph object at the first position in the virtual space, wherein the first guide object comprises information for notifying the first user of the first position in the virtual space.

### TECHNICAL FIELD

This disclosure relates to photography in a virtual space, and more particularly, to processing after photography has been performed in a virtual space.

### BACKGROUND

A technology for providing a virtual space by using a head-mounted device (HMD) is known. There have been proposed various technologies for enriching an experience of a user in the virtual space.

For example, in Non-Patent Document 1, there is described a technology in which a subject, for example, an avatar, is photographed by using an instant camera arranged in a virtual space. In Non-Patent Document 2, there is described a technology in which an avatar arranged in a virtual space is photographed by a virtual camera.

### RELATED ART

### Non-Patent Documents

[Non-Patent Document 1] “VR Inside—Business Media Creating Future of VR; Dig4 Destruction”, [online], [retrieved on Jun. 13, 2017], Internet <URL: http://bank.vrinside.jp/review/dig-4-destruction/>
[Non-Patent Document 2] “Oculus demos a VR Selfie Stick and Avatar” [online], [retrieved on Jun. 13, 2017], Internet (URL: http://jp.techcrunch.com/2016/04/14/20160413vr-selfie-stick/)

### SUMMARY

According to at least one embodiment of the present invention, there is provided a method of providing a virtual space, the method including: defining a virtual space, the virtual space including a first avatar object, the first avatar object being associated with a first user, the first user being associated with a first head-mounted device; determining a field of view of the first user based on a first virtual camera arranged in the virtual space; displaying an image corresponding to the field of view of the first user on the first head-mounted device; arranging a first photography object in the virtual space, the first photography object including a user interface (UI) configured to receive from the first user a first operation of photographing in the virtual space; identifying a photography range of the first photography object in response to receiving the first operation from the first user; rendering an image corresponding to the identified photography range; arranging, in response to the rendering, a first photograph object in the virtual space at a first position determined in advance, the first photograph object including the rendered image; and arranging a first guide object in the field of view of the first user in response to the arranging of the first photograph object at the first position in the virtual space, the first guide object including information for notifying the first user of the first position in the virtual space.

The above-mentioned and other objects, features, aspects, and advantages of the disclosure may be made clear from the following detailed description of this disclosure, which is to be understood in association with the attached drawings.

### BRIEF DESCRIPTION OF THE DRAWINGS

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of a coordinate system to be set for a hand of a user holding the controller according to at least one embodiment of this disclosure.

FIG. 9 A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field of view image of a HMD according to at least one embodiment of this disclosure.

FIG. 13 A sequence diagram of processing to be executed by a system including an HMD interacting in a network according to at least one embodiment of this disclosure.

FIG. 14 A block diagram of a detailed configuration of modules of the computer according to at least one embodiment of this disclosure.

FIG. 15 A diagram (part 1) of a technical concept according to at least one embodiment of this disclosure.

FIG. 16 A diagram (part 2) of a technical concept according to at least one embodiment of this disclosure.

FIG. 17 A diagram of processing of tracking a hand according to at least one embodiment of this disclosure.

FIG. 18 A diagram of a motion of a tracking module according to at least one embodiment of this disclosure.

FIG. 19 A diagram of an example of a data structure of tracking data according to at least one embodiment of this disclosure.

FIG. 20 A flowchart of an example of processing to be executed by the HMD system according to at least one embodiment of this disclosure.

FIG. 21 A diagram of a hardware configuration and a module configuration of a server according to at least one embodiment of this disclosure.

FIG. 22 A diagram of processing of generating a photograph image by photography in a virtual space according to at least one embodiment of this disclosure.

FIG. 23 A diagram of processing of notifying the user of a direction of an accumulation place according to at least one embodiment of this disclosure.

FIG. 24 A diagram of processing of notifying the user of a trajectory to the accumulation place according to at least one embodiment of this disclosure.

FIG. 25 A diagram of processing of notifying the user that a photograph object is arranged at the accumulation place according to at least one embodiment of this disclosure.

FIG. 26 A flowchart of processing of notifying a series of accumulation places to the user according to at least one embodiment of this disclosure.

FIG. 27 A diagram of processing on a photograph image represented by a photograph object according to at least one embodiment of this disclosure.

FIG. 28 A table of an example of a data structure of a photograph DB stored by the server according to at least one embodiment of this disclosure.

FIG. 29 A flowchart of an example of processing in which the server receives an evaluation regarding the photograph image according to at least one embodiment of this disclosure.

FIG. 30 A flowchart of processing in which the computer and the server work together to post a photograph image on an SNS according to at least one embodiment of this disclosure.

FIG. 31 A table of an example of the data structure of a user DB according to at least one embodiment of this disclosure.

FIG. 32 A diagram of processing of deleting the photograph object according to at least one embodiment of this disclosure.

FIG. 33 A diagram (part 1) of processing of generating a spirit photograph according to at least one embodiment of this disclosure.

FIG. 34 A diagram of (part 2) of processing of generating a spirit photograph according to at least one embodiment of this disclosure.

FIG. 35 A diagram of processing of generating a photograph image including an avatar object having a display mode different from that of an avatar object arranged in the virtual space according to at least one embodiment of this disclosure.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

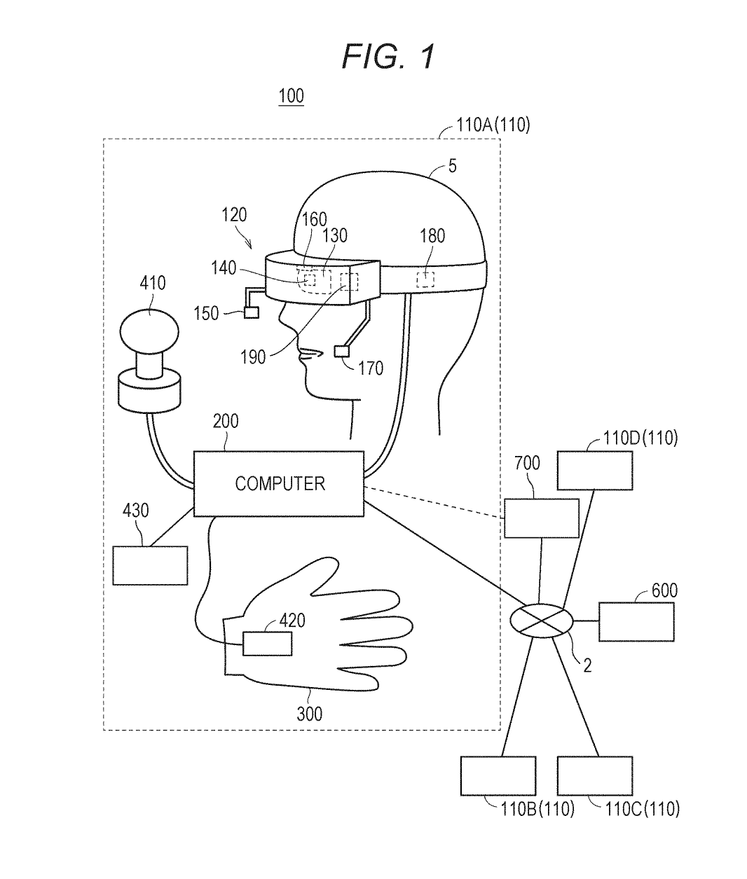

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least any one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

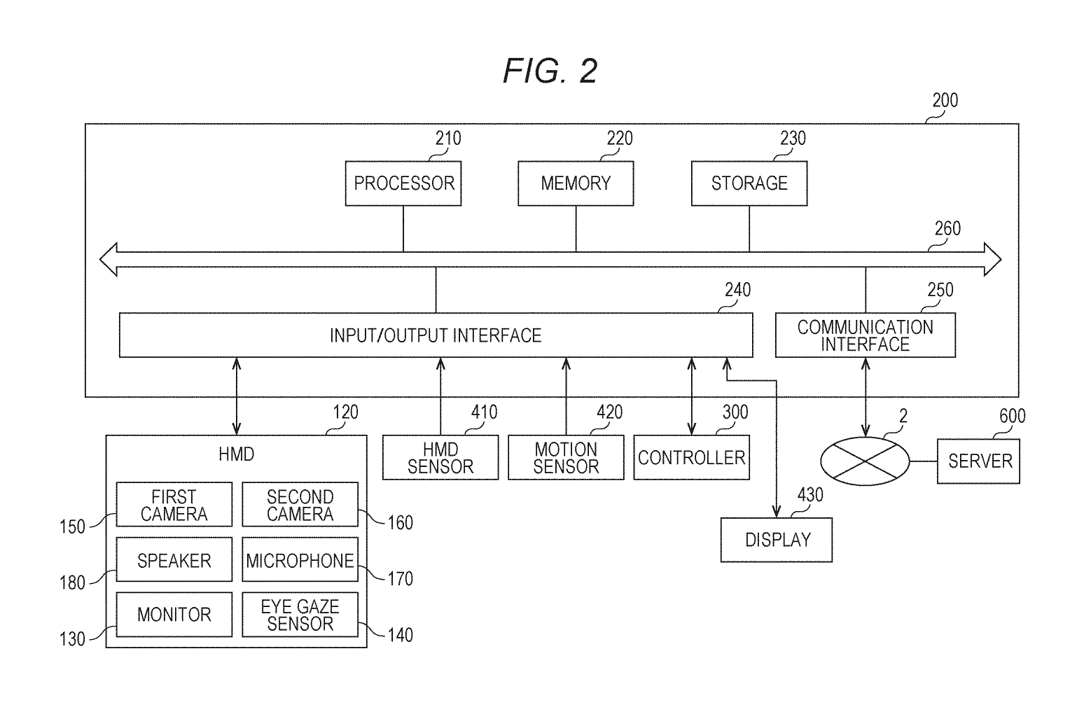

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth®, near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

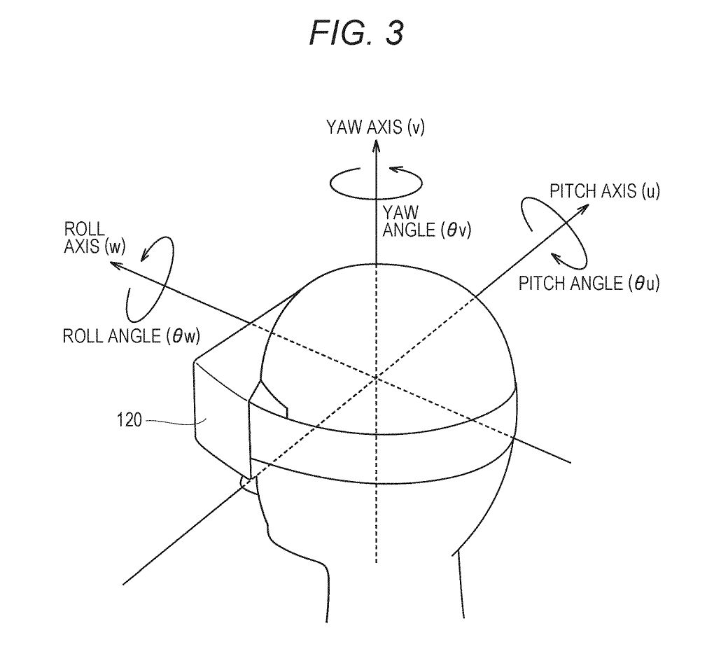

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

[Virtual Space]

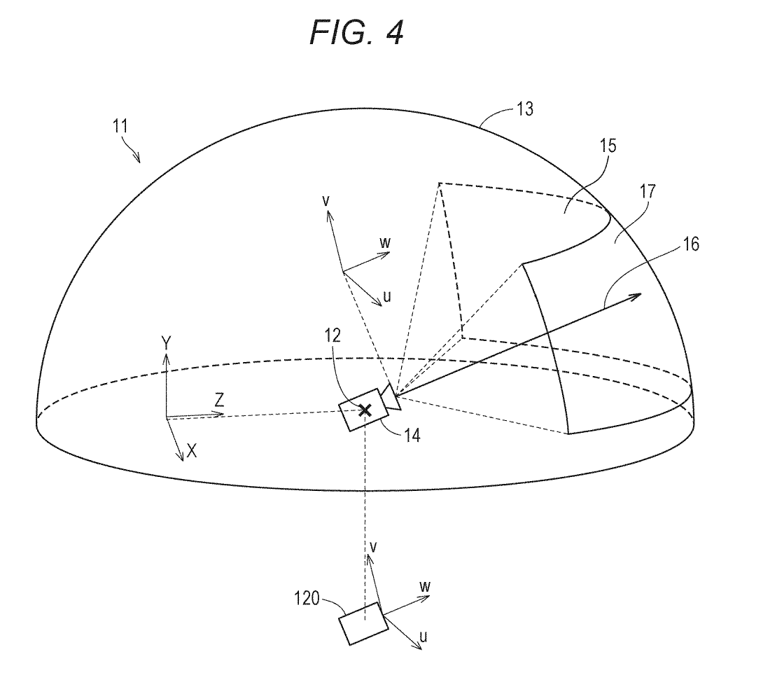

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

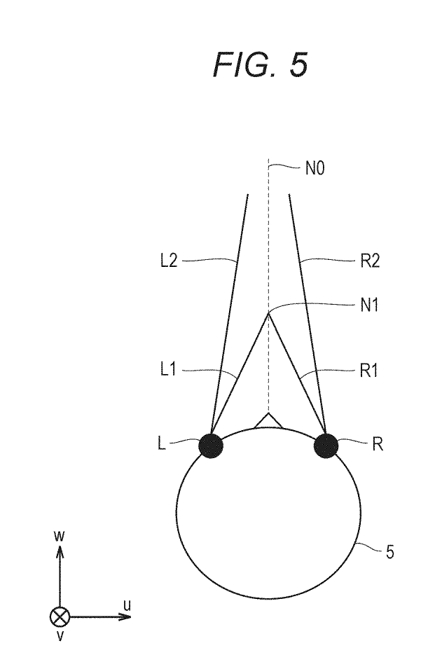

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight NO of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight NO. The line of sight NO is a direction in which the user 5 actually directs his or her lines of sight with both eyes. The line of sight NO corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-of-View Region]

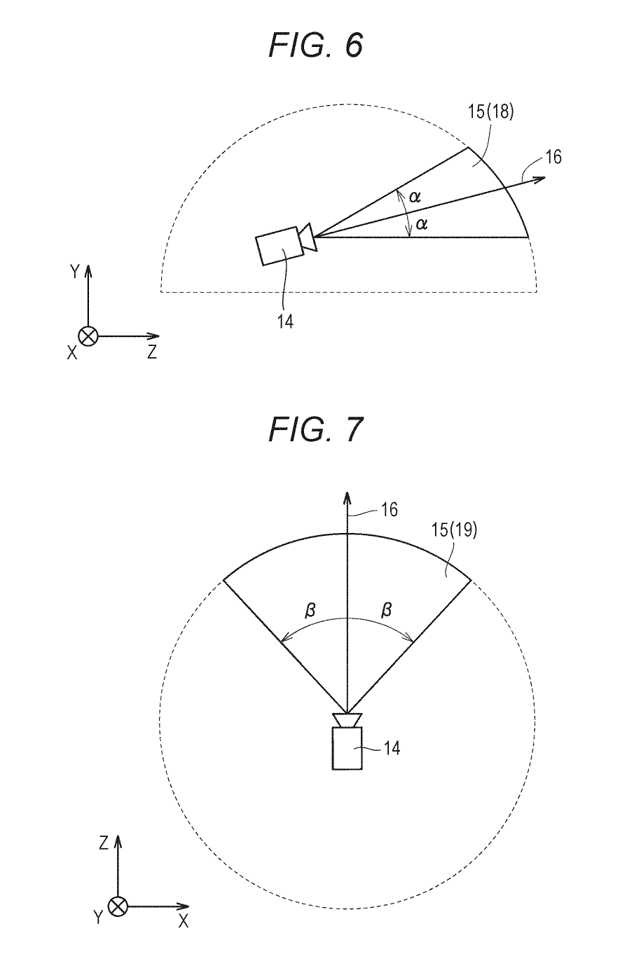

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to apart of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

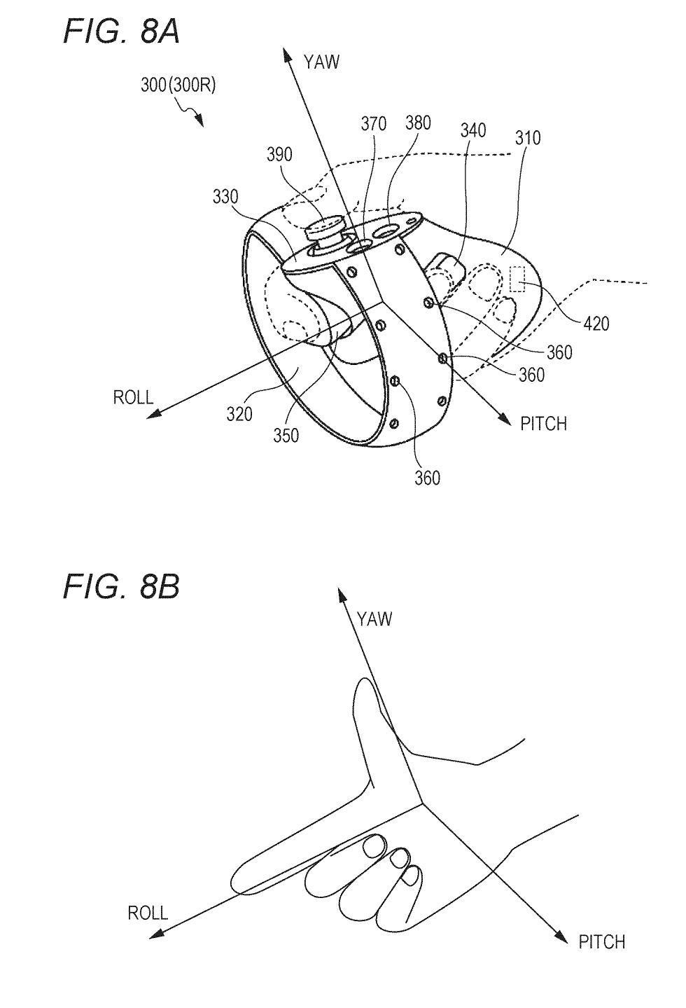

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIG. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

[Hardware Configuration of Server]

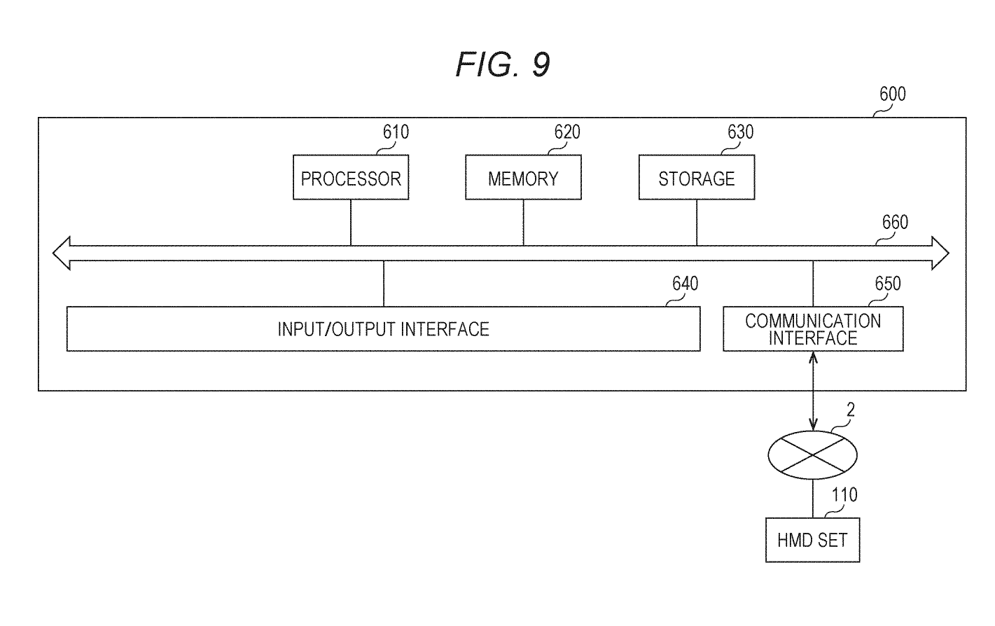

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

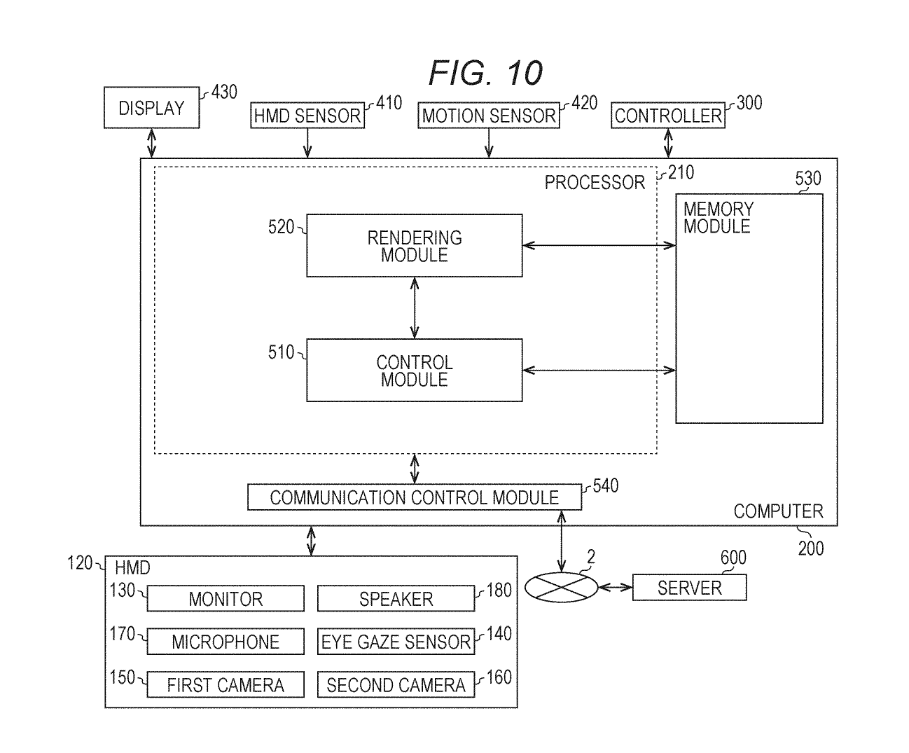

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity® provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

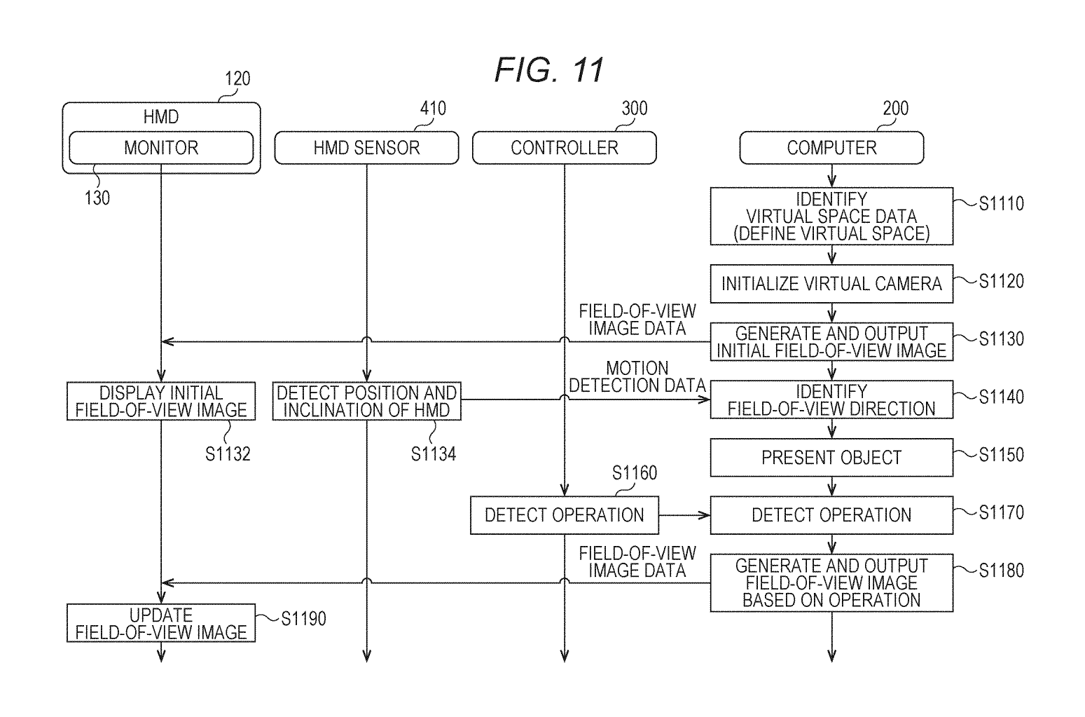

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

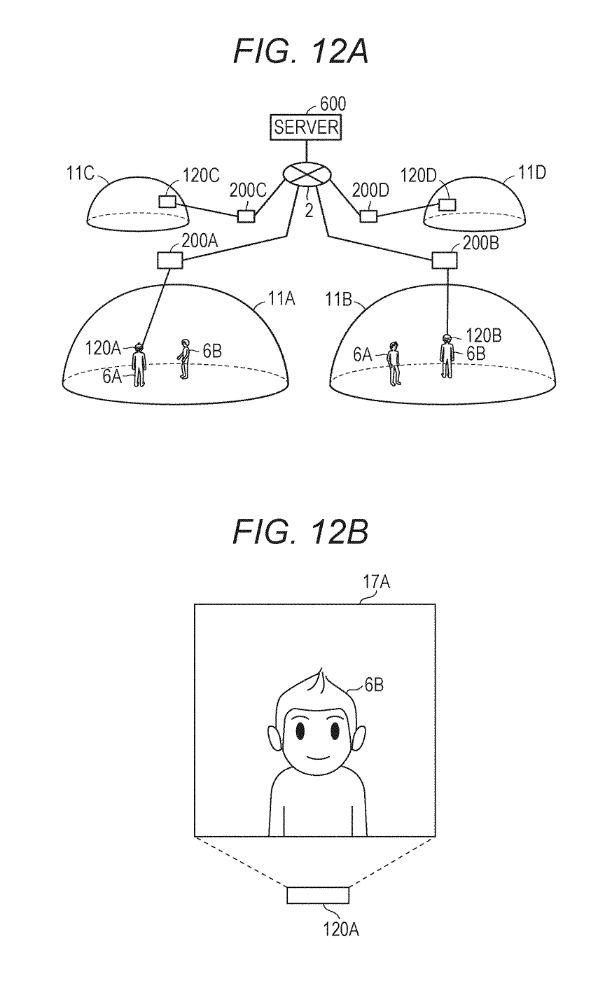

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

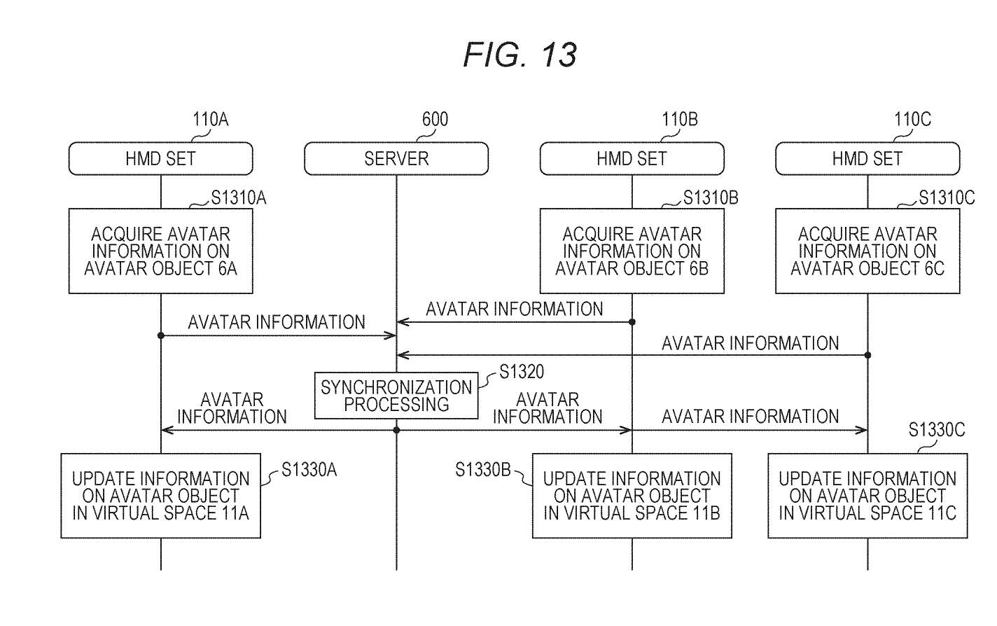

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 10C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Detailed Configuration of Modules]

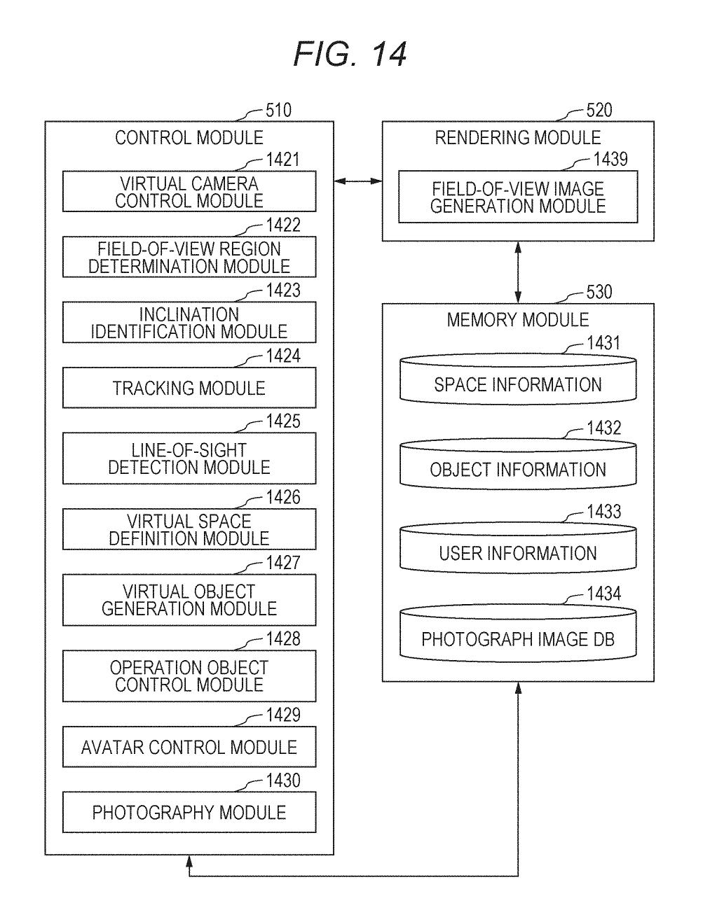

With reference to FIG. 14, details of a module configuration of the computer 200 are described. FIG. 14 is a block diagram of a detailed configuration of modules of the computer 200 according to at least one embodiment of this disclosure.

In FIG. 14, the control module 510 includes a virtual camera control module 1421, a field-of-view region determination module 1422, an inclination identification module 1423, a tracking module 1424, a line-of-sight detection module 1425, a virtual space definition module 1426, a virtual object generation module 1427, an operation object control module 1428, an avatar control module 1429, and a photography module 1430. The rendering module 520 includes a field-of-view image generation module 1439. The memory module 530 stores space information 1431, object information 1432, user information 1433, and a photograph image DB 1434.

The virtual camera control module 1421 arranges the virtual camera 14 in the virtual space 11. The virtual camera control module 1421 controls a position of the virtual camera 14 in the virtual space 11 and the inclination (photography direction) of the virtual camera 14. The field-of-view region determination module 1422 determines the field-of-view region 15 based on the position and inclination of the virtual camera 14. The field-of-view image generation module 1439 generates the field-of-view image 17 to be displayed on the monitor 130 based on the determined field-of-view region 15.

The inclination identification module 1423 identifies the inclination (i.e., reference-line-of-sight 16) of the HMD 120 based on output of the sensor 190 or the HMD sensor 410.

The tracking module 1424 detects (tracks) the position of a part of the body of the user 5. In at least one embodiment, the tracking module 1424 detects the position of the hand of the user 5 in the uvw visual field coordinate system set in the HMD 120 based on the depth information input from the third camera 165. The motion of the tracking module 1424 is described later.

The line-of-sight detection module 1425 detects the line of sight of the user 5 in the virtual space 11 based on a signal from the eye-gaze sensor 140.

The control module 510 controls the virtual space 11 provided to the user 5. The virtual space definition module 1426 defines the size and shape of the virtual space 11. The virtual space definition module 1426 develops a panorama image 13 in the virtual space 11.

The virtual object generation module 1427 generates an object to be arranged in the virtual space 11 based on the object information 1432 to be described later. The object includes the above-mentioned camera object 1541. The object may also include a tree, an animal, a person, and the like.

The operation object control module 1428 arranges in the virtual space 11 an operation object that moves in accordance with an operation of the user 5 in the virtual space 11. The user 5 moves the operation object to operate, for example, an object arranged in the virtual space 11. In at least one aspect, the operation object includes, for example, a hand object of the avatar object corresponding to the hand of the user 5. In at least one aspect, the operation object corresponds to a hand part of an avatar object to be described later. In at least one aspect, the operation object includes an object (e.g., stick) held by the avatar object.

The avatar control module 1429 generates data for arranging an avatar object of the user 5 corresponding to a user of another computer 200, which is connected via the network, in the virtual space 11. In at least one aspect, the avatar control module 1429 generates data for arranging an avatar object corresponding to the user 5 in the virtual space 11. In at least one aspect, the avatar control module 1429 generates an avatar object simulating the user 5 based on an image containing the user 5. In at least one aspect, the avatar control module 1429 generates data for arranging in the virtual space 11 an avatar object that is selected by the user 5 from among a plurality of types of avatar objects (e.g., objects simulating animals or objects of deformed humans).

The avatar control module 1429 translates the inclination identified by the inclination identification module 1423 in the avatar object. For example, in accordance with the inclination of the HMD 120, the avatar control module 1429 generates data of the inclined avatar object. Based on output of the tracking module 1424, the avatar control module 1429 translates the motion of the hand of the user 5 in the real space in the hand of the avatar object. The avatar control module 1429 controls the motion of the avatar object corresponding to the user of another computer based on the data input from another computer 200.

The photography module 1430 generates a photograph image. More specifically, the photography module 1430 arranges a camera object having a photography function in the virtual space 11, and generates a photograph image corresponding to the photography range of the camera object in accordance with a photography instruction of the user 5. The generated photograph image is stored in the storage 230.

The space information 1431 includes one or more templates defined in order to provide the virtual space 11. The virtual space definition module 1426 defines the virtual space 11 in accordance with those one or more templates. The space information 1431 further includes a plurality of panorama images 13 to be developed in the virtual space 11. The panorama image 13 may include a still image and a moving image. The panorama image 13 may include an image in the real space and an image in a non-real space (e.g., computer graphics).

The object information 1432 stores modeling data for constructing an object arranged in the virtual space 11, information on an initial arrangement position of the object, and the like.

The user information 1433 contains a user ID for identifying the user 5. The user ID may be, for example, an internet protocol (IP) address or a media access control (MAC) address set to the computer 200 used by the user. In at least one aspect, the user ID is set by the user. The user information 1433 contains, for example, a program for causing the computer 200 to function as the control device of the HMD system 100.

The photograph image DB 1434 stores the photograph image generated by the photography module 1430 and identification information (hereinafter also referred to as “photograph ID”) for identifying the photograph image in association with each other.

[Technical Concept]

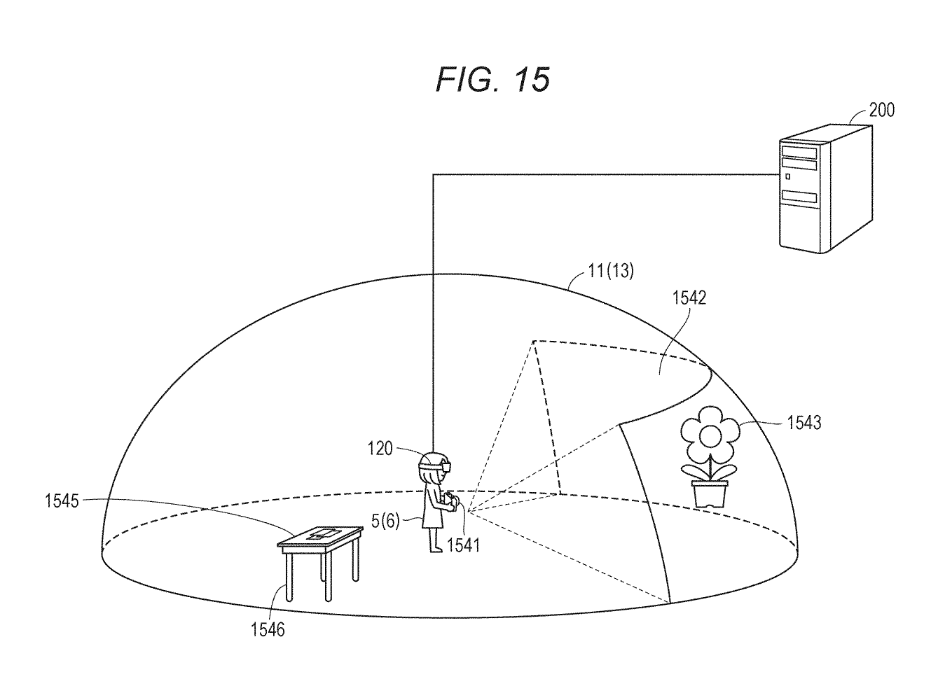

FIG. 15 is a diagram (part 1) of the technical concept according to at least one embodiment of this disclosure. With reference to FIG. 15, the computer 200 provides the virtual space 11 to the HMD (head-mounted device) 120 worn by the user 5. The computer 200 develops the panorama image 13 in the virtual space 11.

The computer 200 arranges the avatar object 6 corresponding to the user 5 in the virtual space 11. The avatar object 6 of FIG. 5 wears the HMD 120 for the sake of convenience of description, but in actuality, the avatar object 6 does not wear the HMD 120. The computer 200 further displays on the monitor of the HMD 120 an image corresponding to the field-of-view region of the avatar object 6. As a result, the user 5 visually recognizes the panorama image 13. The computer 200 arranges in the virtual space 11 the camera object 1541 having a photography function.

The avatar object 6 moves in accordance with the operation of the user 5. The user 5 operates the camera object 1541 with the avatar object 6 to photograph the virtual space 11 (panorama image 13 developed in the virtual space 11).

In the example of FIG. 15, a photography range 1542 of the camera object 1541 includes a flower 1543, which is a portion of the panorama image 13. Under this state, the user 5 performs an operation for performing photography by the camera object 1541. The computer 200 generates an image corresponding to the photography range 1542 based on the operation. The image generated by the photography in the virtual space is hereinafter also referred to as “photograph image”.

Each time photography is performed in the virtual space 11, the computer 200 generates a photograph object 1545 representing the photograph image generated by the photography. The computer 200 arranges the photograph object 1545 in the virtual space 11 at a position determined in advance. In the example of FIG. 15, the computer 200 arranges the photograph object 1545 on a table object 1546.

The user 5 moves to the table object 1546 in the virtual space 11, and confirms the generated photograph image. However, the user 5 may not know the position at which the photograph object 1545 is arranged. In such a case, the user 5 is required to find the position (table object 1546) at which the photograph object 1545 is arranged by moving in the virtual space 11. Processing capable of solving such a problem is described later.

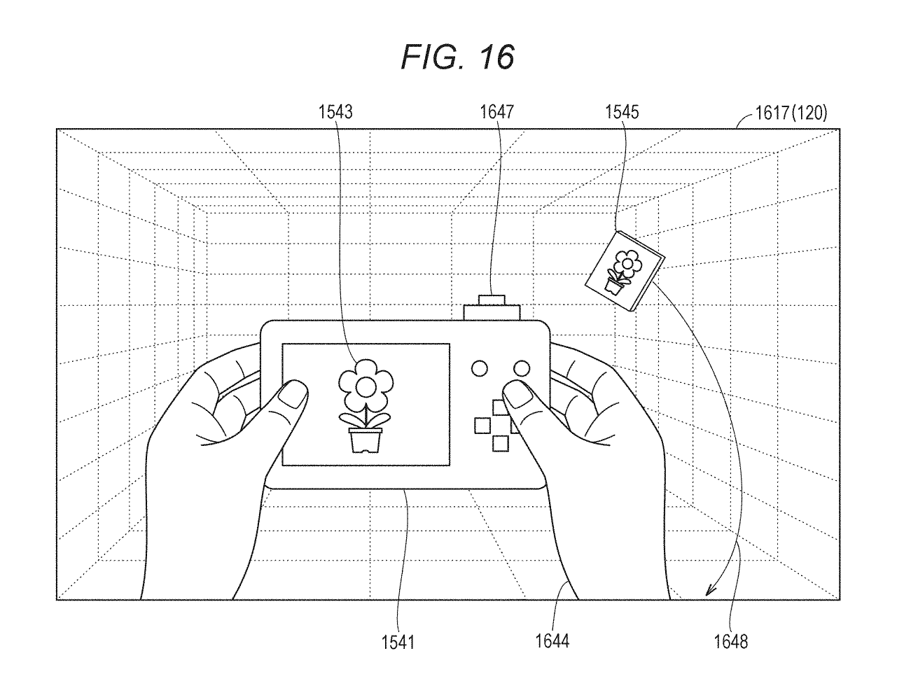

FIG. 16 is a diagram (part 2) of the technical concept of this disclosure according to at least one embodiment of this disclosure. Under the state of FIG. 16, the user 5 is visually recognizing a field-of-view image 1617 developed on the monitor of the HMD 120.

The field-of-view image 1617 includes a hand object 1644 corresponding to a hand part of the avatar object 6 and the camera object 1541. The camera object 1541 has a preview screen. In the example of FIG. 16, the preview screen includes a flower 1543. The computer 200 executes photography in the virtual space 11 when a press of a button 1647 arranged on the camera object 1541 by the hand object 1644 is received. As a result, the computer 200 generates a photograph image and stores the generate photograph image in a memory (not shown).

Further, the computer 200 generates a photograph object 1545 representing the photograph image, and arranges the object near the camera object 1541. The computer 200 also moves the photograph object 1545 to the position of the table object 1546.

With the configuration described above, the user 5 is able to easily understand the position at which the photograph object 1545 is arranged by confirming a trajectory 1648 along which the photograph object 1545 moves. A specific configuration and control for implementing such processing are now described.

[Hand Tracking]

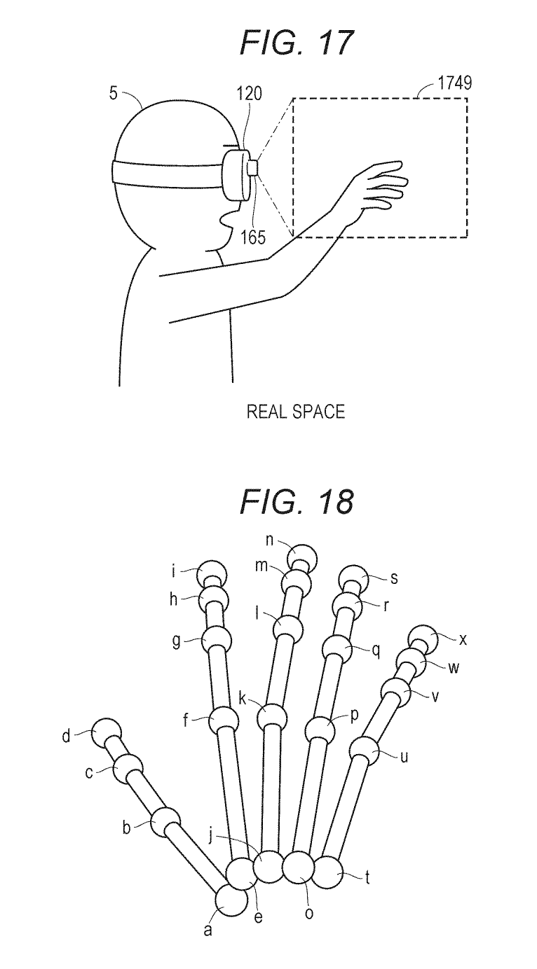

Next, with reference to FIG. 17 to FIG. 19, a description is given of processing of tracking a motion of the hand of the user 5. FIG. 17 is a diagram of processing of tracking a hand according to at least one embodiment of this disclosure.

Referring to FIG. 17, the user 5 is wearing the HMD 120 in the real space. The third camera 165 is mounted on the HMD 120. The third camera 165 acquires depth information on objects contained in a space 1749 ahead of the HMD 120. In the example illustrated in FIG. 17, the third camera 165 acquires depth information on a hand of the user 5 contained in the space 1749.

The third camera 165 is capable of acquiring depth information on a target object. As an example, the third camera 165 acquires depth information on a target object in accordance with a time-of-flight (TOF) method. As another example, the third camera 165 acquires depth information on a target object in accordance with a pattern irradiation method. In at least one embodiment, the third camera 165 is a stereo camera capable of photographing a target object from two or more different directions. The third camera 165 may be a camera capable of photographing infrared rays, which are invisible to people. The third camera 165 is mounted on the HMD 120 and photographs a part of the body of the user 5. In the following description, as an example, the third camera 165 photographs a hand of the user 5. The third camera 165 outputs the acquired hand depth information on the hand of the user 5 to the computer 200.

The tracking module 1424 generates position information on the hand (hereinafter also referred to as “tracking data”) based on the depth information. The third camera 165 is mounted on the HMD 120. Therefore, the tracking data indicates a position in the uvw visual-field coordinate system set in the HMD 120.

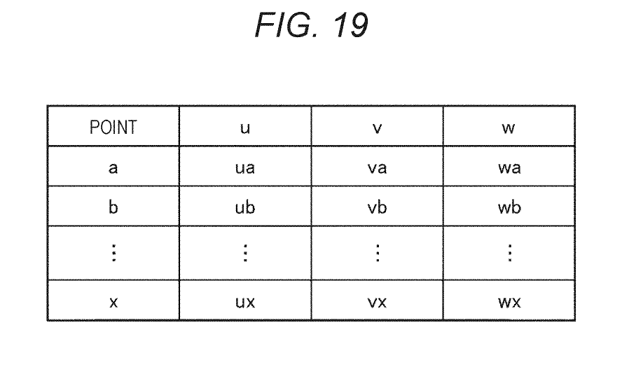

FIG. 18 is a diagram of a motion of the tracking module 1424 according to at least one embodiment of this disclosure. In at least one aspect, the tracking module 1424 tracks the motion of the joints of the hand of the user 5 based on the depth information input from the third camera 165. In FIG. 18, the tracking module 1424 detects the position of each of joints a, b, c . . . , x of the hand of the user 5.

The tracking module 1424 is capable of recognizing a shape (finger motion) of the hand of the user 5 based on the positional relationship among the joints a to x. The tracking module 1424 is able to recognize, for example, that the hand of the user 5 is pointing with a finger, that the hand is open, that the hand is closed, that the hand is performing a motion of grasping something, that the hand is twisted, and that the hand is taking a shaking-hand shape. The tracking module 1424 is also able to determine whether the recognized hand is a left hand or a right hand based on the positional relationship between the joints a to d and other joints. Such a third camera 165 and tracking module 1424 may be implemented by, for example, Leap Motion (trademark) provided by Leap Motion, Inc.

FIG. 19 is a table of an example of the data structure of the tracking data according to at least one embodiment of this disclosure. The tracking module 1424 acquires tracking data for each of the joints a to x. Those pieces of tracking data represent position information in the uvw visual-field coordinate system set in the HMD 120.

The avatar control module 1429 translates the detected tracking data in the avatar object. As an example, vertices corresponding to the pieces of tracking data are set to some of the vertices of polygons forming the hand of the avatar object. The avatar control module 1429 moves the positions of those vertices based on the tracking data. As a result, the motion of the hand of the user 5 in the real space is translated in the motion of the hand of the avatar object in the virtual space.

[Control Structure of Computer 200]

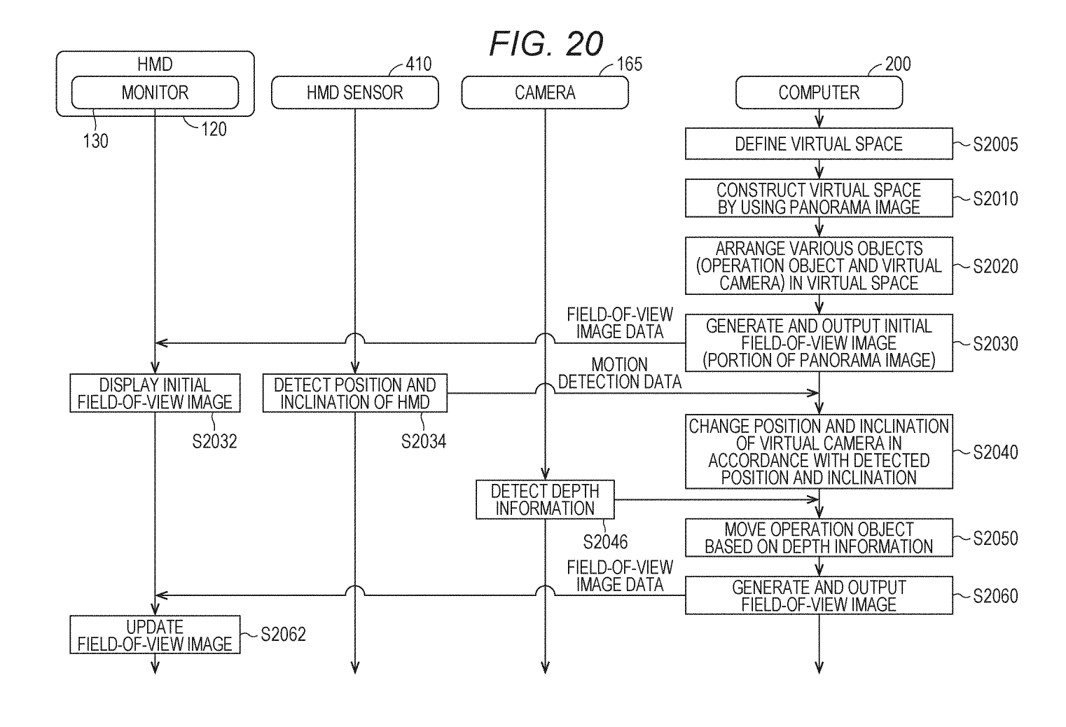

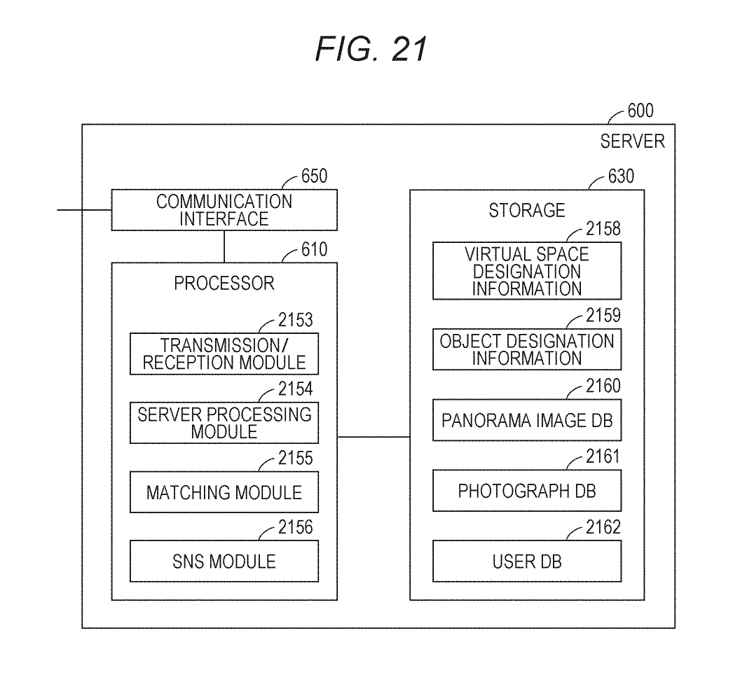

Next, a control structure of the computer 200 according to at least one embodiment of this disclosure is now described with reference to FIG. 20. FIG. 20 is a flowchart of an example of processing to be executed by the HMD system 100 according to at least one embodiment of this disclosure.

In Step S2005, the processor 210 of the computer 200 serves as the virtual space definition module 1426 to define the virtual space 11.

In Step S2010, the processor 210 constructs the virtual space 11 by using the panorama image 13. More specifically, the processor 210 develops a partial image of the panorama image 13 on each mesh forming the virtual space 11.

In Step S2020, the processor 210 arranges various objects including the virtual camera 14 and operation object in the virtual space 11. At this time, the processor 210 arranges, in a work area of the memory, the virtual camera 14 at a center 21 defined in advance in the virtual space 11.

In Step S2030, the processor 210 serves as the field-of-view image generation module 1439 to generate field-of-view image data for displaying the initial field-of-view image 17 (portion of the panorama image 13). The generated field-of-view image data is transmitted to the HMD 120 by the communication control module 540.

In Step S2032, the monitor 130 of the HMD 120 displays the field-of-view image 17 based on the signal received from the computer 200. As a result, the user 5 wearing the HMD 120 recognizes the virtual space 11.

In Step S2034, the HMD sensor 410 detects the position and inclination (motion of user 5) of the HMD 120 based on a plurality of infrared rays output by the HMD 120. The detection result is transmitted to the computer 200 as motion detection data.

In Step S2040, the processor 210 serves as the virtual camera control module 1421 to change the position and inclination of the virtual camera 14 based on the motion detection data input from the HMD sensor 410. As a result, the position and inclination (reference line of sight 16) of the virtual camera 14 are updated in association with the motion of the head of the user 5. The field-of-view region determination module 1422 defines the field-of-view region 15 in accordance with the position and inclination of the virtual camera 14 after the change.

In Step S2046, the third camera 165 detects the depth information on the hand of the user 5, and transmits the detected depth information to the computer 200.

In Step S2050, the processor 210 serves as the tracking module 1424 to detect the position of the hand of the user 5 in the uvw visual-field coordinate system based on the received depth information. The processor 210 then serves as the operation object control module 1428 to move the operation object in association with the detected position of the hand of the user 5. When a user operation on another object is received because, for example, the operation object has touched another object, the processor 210 executes processing determined in advance for the operation.

As described above, the operation object may be a hand part of the avatar object corresponding to the user 5. In this case, the processor 210 serves as the avatar control module 1429 to move the hand part of the avatar object in association with the position of the hand of the user 5.

In Step S2060, the processor 210 serves as the field-of-view image generation module 1439 to generate field-of-view image data for displaying the field-of-view image 17 photographed by the virtual camera 14, and outputs the generated field-of-view image data to the HMD 120.

In Step S2062, the monitor 130 of the HMD 120 displays the updated field-of-view image based on the received field-of-view image data. As a result, the field of view of the user in the virtual space 11 is updated.

[Control Structure of Server 600]

FIG. 21 is a diagram of a hardware configuration and a module configuration of the server 600 according to at least one embodiment of this disclosure. In at least one embodiment, the server 600 includes a communication interface 650, a processor 610, and a storage 630 as main hardware.

The communication interface 650 functions as a communication module for wireless communication, which is configured to perform, for example, modulation/demodulation processing for transmitting/receiving signals to/from an external communication device, for example, the computer 200. The communication interface 650 is implemented by, for example, a tuner or a high frequency circuit.

The processor 610 controls operation of the server 600. The processor 610 executes various control programs stored in the storage 630 to function as a transmission/reception module 2153, a server processing module 2154, a matching module 2155, and a social networking service (SNS) module 2156.

The transmission/reception module 2153 transmits and receives various kinds of information to/from each computer 200. For example, the transmission/reception module 2153 transmits to each computer 200 a request that an object be arranged in the virtual space 11, a request that an object be deleted from the virtual space 11, a request that an object be moved, a sound of the user, and information for defining the virtual space 11.

The server processing module 2154 updates a photograph database (DB) 2161 and a user DB 2162, which are described later, based on the information received from each computer 200.

The matching module 2155 performs a series of processing steps for associating a plurality of users. For example, when an input operation for the plurality of users to share the same virtual space 11 is performed, the matching module 2155 performs, for example, processing of associating respective user IDs of those plurality of users belonging to the virtual space 11 with one another.

The SNS module 2156 posts the photograph image designated by the computer 200 (user 5) among a plurality of photograph images stored in the photograph DB 2161 on an SNS registered in advance for each user 5 (e.g., another server connected to network 2).

The storage 630 stores virtual space designation information 2158, object designation information 2159, a panorama image DB 2160, the photograph DB 2161, and the user DB 2162.

The virtual space designation information 2158 is information to be used by the virtual space definition module 1426 of the computer 200 to define the virtual space 11. For example, the virtual space designation information 2158 includes information for designating the size or shape of the virtual space 11.

The object designation information 2159 designates an object to be arranged (generated) in the virtual space 11 by the virtual object generation module 1427 of the computer 200. The panorama image DB 2160 stores a plurality of panoramas image 13 to be distributed to the computer 200 and identification information (hereinafter also referred to as “panorama image ID”) for identifying each panorama image 13 in association with each other.

The photograph DB 2161 stores the photograph images received from each computer 200. The user DB 2162 stores information (user ID) identifying each of a plurality of users and information required for the SNS module 2156 to post a photograph image on the SNS in association with each other.

[Photography in Virtual Space]

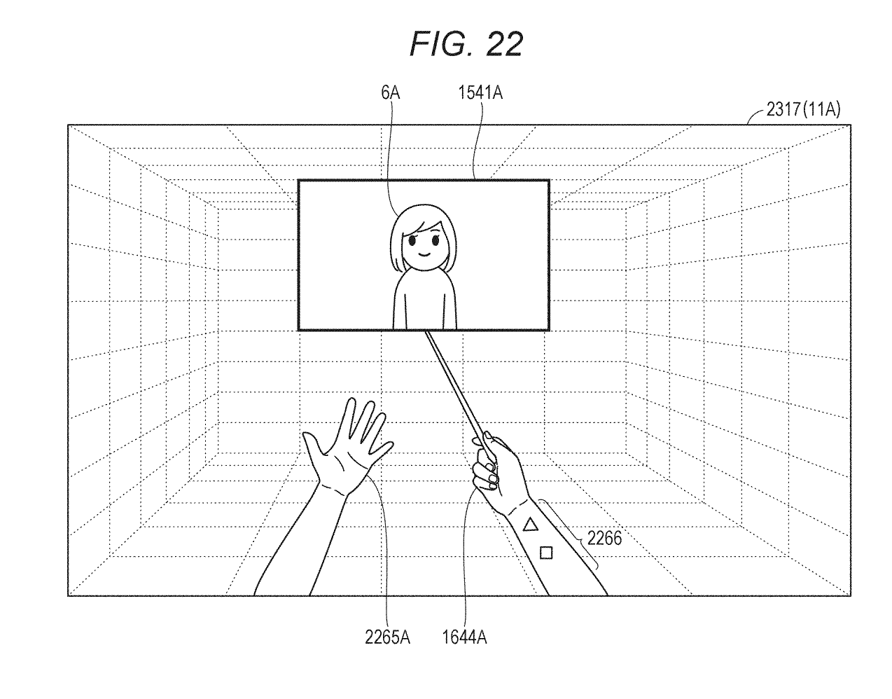

FIG. 22 is a diagram of processing of generating a photograph image by photography in a virtual space according to at least one embodiment of this disclosure. In FIG. 22, as an example, there is illustrated a situation in which the user 5A is photographing the virtual space 11A.

A field-of-view image 2217 visually recognized by the user 5A includes a right hand object 1644A corresponding to the right hand of the avatar object 6A, a left hand object 2265A corresponding to the left hand of the avatar object 6A, an avatar object 6B, and a camera object 1541A. The right hand object 1644A and the left hand object 2265A function as operation objects.

The camera object 1541A has a photography function. As an example, the camera object 1541A is a rectangular object having a front surface and a back surface, and the front surface functions as a preview screen.

The right hand object 1644A is holding a stick supporting the camera object 1541A. Self-photography sticks (also called selfie sticks or selca (self-camera) sticks) supporting a smartphone (or device having photography function) are widely known by the public. Therefore, through presenting together the camera object 1541A having a preview screen and the stick-like support member, there is a higher possibility that the user 5A is aware of the photography function of the camera object 1541A.

The camera object 1541A is capable of switching between a front-facing camera mode for photographing a front side and a rear-facing camera mode for photographing a rear side. In the example of FIG. 28, the camera object 1541A functions in the front-facing camera mode. Therefore, on the front surface (preview screen) of the camera object 1541A, the avatar object 6A is displayed.

A right arm of the avatar object 6 includes a user interface (UI) object 2266. The computer 200A arranges the UI object 2266 on the arm supporting the camera object 1541A. In at least one aspect, the UI object 2266 functions as a trigger for photography by the camera object 1541A.

The user 5A presses the UI object 2266 with the left hand object 2265A. In accordance with this operation, the computer 200A stores a photograph image corresponding to the photography range 1542 of the camera object 1541A (i.e., image displayed on preview screen) in the photograph image DB 1434A.

[Processing of Notifying User of Position at which Photograph is Arranged]

The processor 210A arranges, when a photograph image is generated, the photograph object 1545 (refer to FIG. 15) representing the photograph image at a position determined in advance in the virtual space 11A (above the table object 1546).

The processor 210A notifies the user 5A of the position at which the photograph object 1545 is arranged (hereinafter also referred to as “accumulation place”). As a result, the user 5A is able to easily confirm the generated photograph image without being confused about where the photograph object 1545 is arranged. A description is now given regarding how the processor 210A notifies the accumulation place to the user 5A.

(Notification of Accumulation Place Direction)

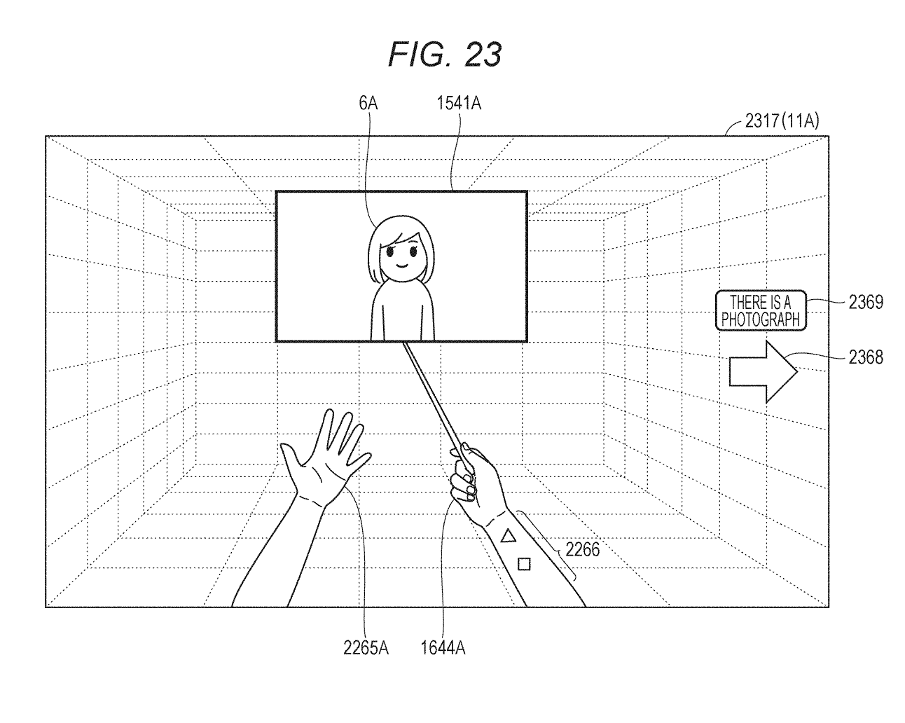

FIG. 23 is a diagram of processing of notifying the user 5A of the direction of the accumulation place according to at least one embodiment of this disclosure. Referring to FIG. 23, a field-of-view image 2317 is different from the field-of-view image 2217 of FIG. 22 in that the field-of-view image 2317 includes a direction object 2368 and a comment object 2369.

In at least one aspect, the processor 210A receives input of a photography instruction (e.g., pressing of UI object 2266 by operation object) from the user 5A. In response to receiving the photography instruction, the processor 210A generates a photograph image.

The processor 210A also arranges in the field-of-view region 15A the direction object 2368 and the comment object 2369 in accordance with input of a photography instruction (or generation of photograph image). Those objects are displayed on the monitor 130A of the HMD 120A.

The direction object 2368 represents the direction of the accumulation place with reference to the position and line-of-sight direction of the user 5A (i.e., position and inclination of the virtual camera 14A) in the virtual space 11A. The comment object 2369 is arranged close to the direction object 2368, and includes a character string (e.g., “There is a photograph”) indicating that the direction object 2368 represents the direction of the accumulation place. In at least one aspect, in accordance with input of a photography instruction, the processor 210A arranges only the direction object 2368, and does not arrange the comment object 2369.

In the example of FIG. 23, the user 5A can visually recognize the direction object 2368 (and comment object 2369) and understand that the accumulation place is on his or her right side.

In the example of FIG. 23, the direction object 2368 is shaped like an arrow, but in at least one aspect, the direction object 2368 has a shape other than an arrow. In such a case, the processor 210A arranges the direction object 2368 at a position closest to the accumulation place in the field-of-view region 15. Accordingly, the user 5A is able to recognize the direction of the accumulation place based on the position at which the direction object 2368 is arranged on the monitor 130A.

The processor 210A deletes the direction object 2368 and the comment object 2369 from the virtual space 11A when a period of time determined in advance (e.g., three seconds) elapses from reception of input of the photography instruction.

(Notification of Trajectory to Accumulation Place)

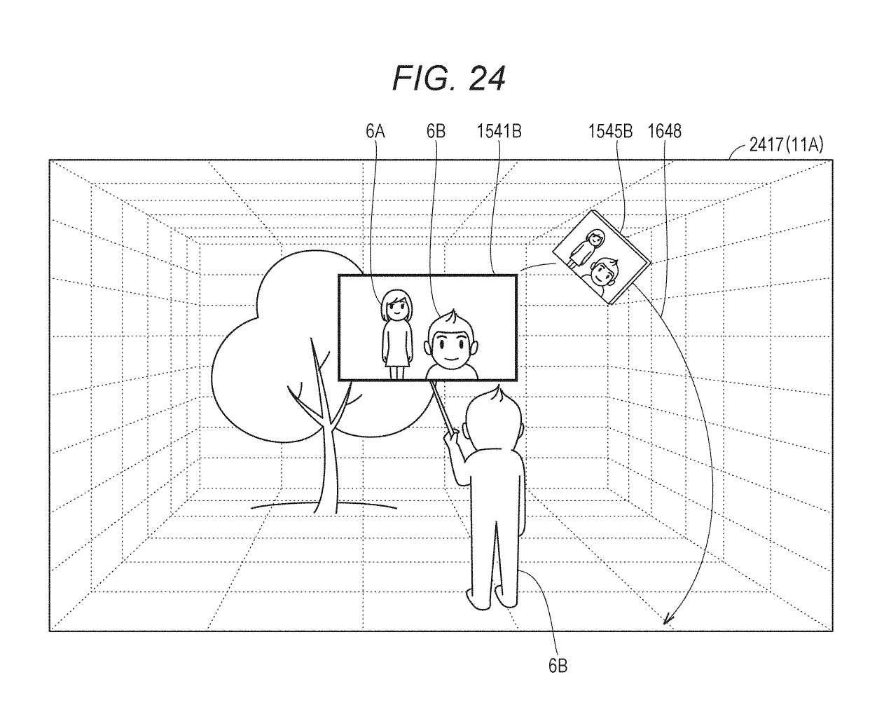

FIG. 24 is a diagram of processing of notifying the user 5A of a trajectory to the accumulation place according to at least one embodiment of this disclosure. A field-of-view image 2417 visually recognized by the user 5A includes an avatar object 6B corresponding to the user 5B.

The avatar object 6B is holding a camera object 1541B. In the example of FIG. 24, the camera object 1541B is set to the front-facing camera mode. Therefore, on the preview screen of the camera object 1541B, the avatar objects 6A and 6B are displayed.

The camera object 1541B is used by the user 5B of the computer 200B to photograph the virtual space 11B. As described above, the computers 200A and 200B share a virtual space. Therefore, the processor 210B arranges the camera object 1541B in the virtual space 11B based on an operation by the user 5B, and transmits to the computer 200A information (e.g., modeling data, and position inclination of the object) on the arranged object. The processor 210A arranges the camera object 1541B in the virtual space 11A based on the received information.

In at least one aspect, the processor 210B of the computer 200B generates a photograph image based on input of a photography instruction from the user 5B. The processor 210B transmits the generated photograph image (data) and the user ID of the user 5B to the computer 200A. The processor 210A generates, based on reception of the photograph image, a photograph object 1545B representing the photograph image. The processor 210A also arranges the photograph object 1545B near the camera object 1541B held by the avatar object 6B corresponding to the received user ID.

In at least one aspect, the processor 210A generates a field-of-view image in which the photograph object 1545B comes out from the camera object 1541B like an instant camera.

The processor 210A also moves the photograph object 1545B from the position of the camera object 1541B to the accumulation place. The user 5A can easily understand where the accumulation place is by checking the trajectory 1648 along which the photograph object 1545 moves. The user 5A can also understand that the user 5B has performed photography through movement of the photograph object 1545B from the camera object 1541B to the accumulation place. As a result, the user 5A is able to promote communication to/from the user 5B by using the newly generated photograph image (photograph object 1545B) as a topic of discussion.

In at least one aspect, the processor 210A arranges an object representing the trajectory 1648 in the virtual space 11A for a period of time determined in advance (e.g., two seconds). In such a case, even when the user 5A misses the moving photograph object 1545B, by confirming the object representing the trajectory 1648, the user 5A is able to understand that the user 5B has performed photography.

In at least one aspect, the processor 210A moves the photograph object 1545 generated by photography from the camera object 1541A to the accumulation place also when the user 5A performs photography by the camera object 1541A. As a result, the user 5A is able to easily understand where the accumulation place is.

(Notification that Photograph Object is Arranged at Accumulation Place)

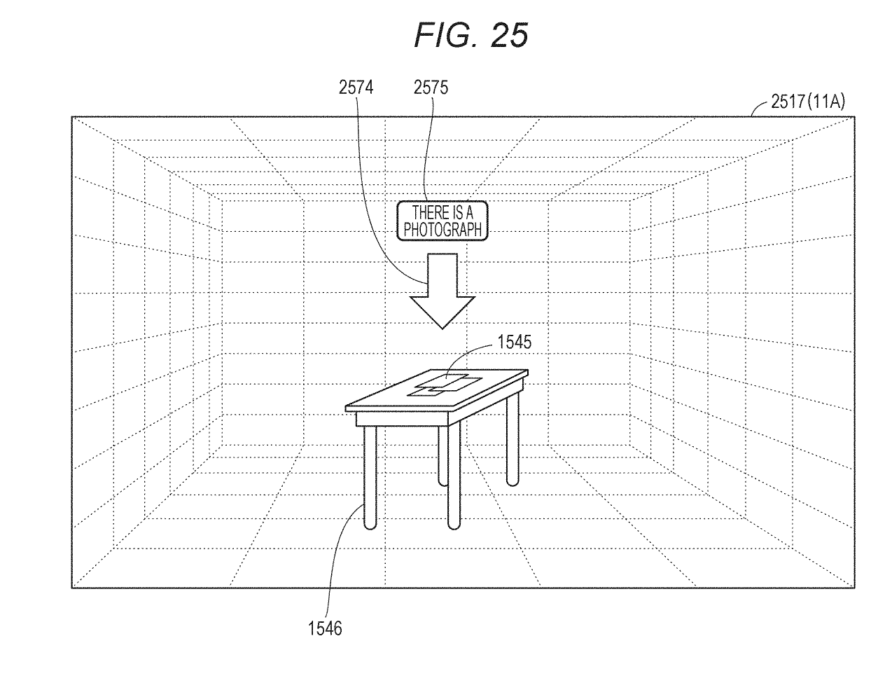

FIG. 25 is a diagram of processing of notifying the user 5A that the photograph object 1545 is arranged at the accumulation place according to at least one embodiment of this disclosure. A field-of-view image 2517 visually recognized by the user 5A includes a table object 1546, a plurality of photograph objects 1545, an icon object 2574, and a comment object 2575.

In at least one aspect, when input of a photography instruction is received from the user 5A, the processor 210A generates a photograph object 1545 and arranges the generated photograph object 1545 on the table object 1546. That is, the position of the table object 1546 is the accumulation place.

The processor 210A arranges the photograph object 1545 on the table object 1546, and arranges the icon object 2574 and the comment object 2575 at a periphery of the table object 1546. In the example of FIG. 25, the processor 210A arranges those objects above the table object 1546.

With the configuration described above, the user 5A is able to easily understand where the accumulation place is in the virtual space 11A by checking the icon object 2574 (and comment object 2575). That is, the icon object 2574 functions as an object indicating that the photograph object 1545 is arranged at the accumulation place (table object 1546).

In at least one aspect, based on the arrangement of the photograph object 1545 on the table object 1546, the processor 210A arranges only the icon object 2574 in the virtual space 11A, and does not arrange the comment object 2575.

In at least one aspect, the processor 210A constantly arranges the icon object 2574 (and comment object 2575) near the table object 1546.

(Control Structure)

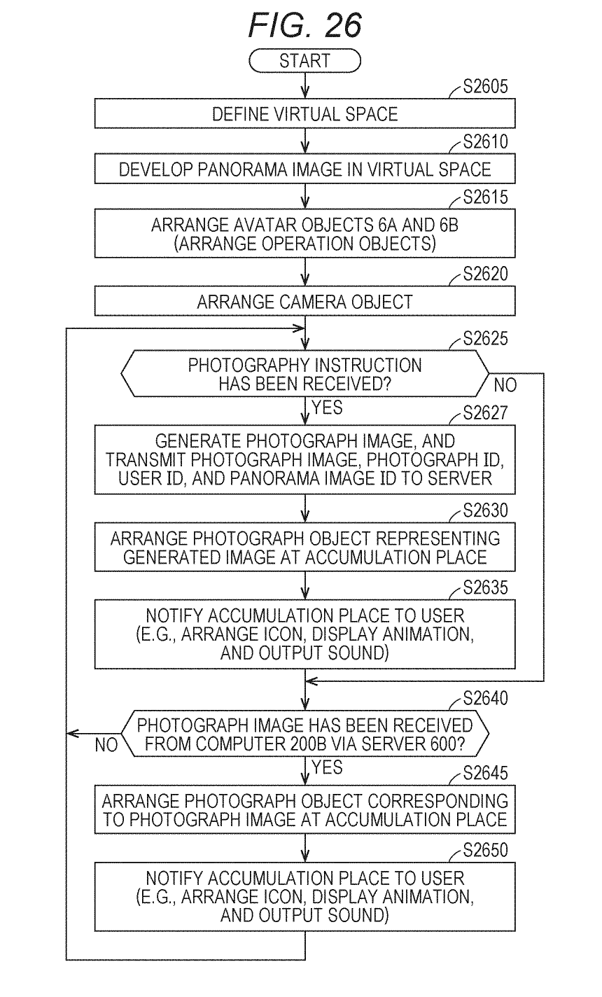

FIG. 26 is a flowchart of processing of notifying a series of accumulation places described above to the user 5A according to at least one embodiment of this disclosure. The processing of FIG. 26 is implemented by the processor 210A reading and executing a control program stored in the memory module 530A.

In Step S2605, the processor 210A serves as the virtual space definition module 1426 to define the virtual space 11A. In Step S2610, the processor 210A develops the panorama image 13 in the virtual space 11A.

In Step S2615, the processor 210A arranges the avatar object 6A in the virtual space 11A. The hand parts (right hand object 1644A and left hand object 2265A) of the avatar object 6A each function as an operation object.

The processor 210A further receives information on the avatar object 6B corresponding to the user 5B from the computer 200B. The processor 210A arranges the avatar object 6B in the virtual space 11A based on the received information.

In Step S2620, the processor 210A arranges the camera object 1541A in the virtual space 11A. As an example, the processor 210A arranges the camera object 1541A in accordance with an operation by the operation object on the UI object 2266 displayed on the arm of the avatar object 6A.

In Step S2625, the processor 210A determines whether input of a photography instruction has been received from the user 5A. As an example, the processor 210A receives input of a photography instruction based on an operation on the UI object 2266 by the operation object.

When it is determined that input of a photography instruction has been received (YES in Step S2625), the processor 210A executes the processing of Step S2627. Otherwise (NO in Step S2625), the processor 210A executes the processing of Step S2640.

In Step S2627, the processor 210A generates a photograph image corresponding to the photography range 1542 of the camera object 1541A. The processor 210A also generates a photograph ID corresponding to the generated photograph image, and stores in the photograph image DB 1434A the photograph image, the photograph ID, and the panorama image ID of the panorama image 13 developed in the virtual space 11A. The processor 210A transmits the photograph image, the photograph ID, the panorama image ID, and the user ID of the user 5A to the server 600. The server 600 updates the photograph DB 2161 based on the received information.

In at least one aspect, the photograph ID generated by each computer 200 includes a user ID. With this configuration, the photograph ID generated by a computer used by a certain user is different from a photograph ID generated by a computer used by another user. Therefore, the server 600 and each computer 200 may identify a single photograph image by using the photograph ID.

In at least one aspect, a uniquely determined photograph ID is generated each time the server 600 receives input of a photograph image from the computer 200. In such a case, the server 600 transmits the generated photograph ID to the computer 200 that is the transmission source of the photograph image. The computer 200 stores the received photograph ID in the photograph image DB 1434 in association with the photograph image.

In Step S2630, the processor 210A arranges the photograph object 1545 representing the generated photograph image at a position determined in advance (accumulation place).

In Step S2635, the processor 210A executes processing of notifying the accumulation place to the user 5A. At this time, the processor 210A may visually notify the accumulation place to the user 5A in the manner described above, or may aurally notify the user 5A by outputting a sound from the speaker 180A (e.g., “The photograph is behind you”).

In Step S2640, the processor 210A determines whether a photograph image has been received from the computer 200B via the server 600. When a photograph image has been received from the computer 200B (YES in Step S2640), the processor 210A executes the processing of Step S2645. Otherwise (NO in Step S2640), the processor 210A again executes the processing of Step S2625.

In Step S2645, the processor 210A arranges the photograph object 1545B representing the photograph image received from the computer 200B at the accumulation place.

In Step S2650, the processor 210A notifies the accumulation place (position at which photograph object 1545B is arranged) to the user 5A.

When the processor 210A performs the processing of moving the photograph object 1545 from the camera object 1541A to the accumulation place in Step S2635, the order of the processing of Step S2630 and the processing of Step S2635 is switched. Similarly, when the processor 210A moves the photograph object 1545B from the camera object 1541B to the accumulation place in Step S2650, the order of the processing of Step S2645 and the processing of Step S2650 is switched.

[Operation on Photograph object]

The user 5A can move the photograph object 1545 arranged in the virtual space 11A by the operation object (avatar object 6A), and browse the photograph image represented by the photograph object 1545. The user 5A can also input, by operating the operation object, an instruction to the computer 200A to perform processing on the photograph object 1545 or on the photograph image represented by the photograph object 1545.

Examples of the processing on the photograph image represented by the photograph object 1545 include processing of evaluating the photograph image represented by the photograph object 1545, processing of editing the photograph image represented by the photograph object 1545, and processing of associating information on a subject included in the photograph image represented by the photograph object 1545 with the photograph image. Examples of the processing on the photograph object 1545 include processing of deleting the photograph object 1545 from the virtual space 11A. Those examples of processing are described below.

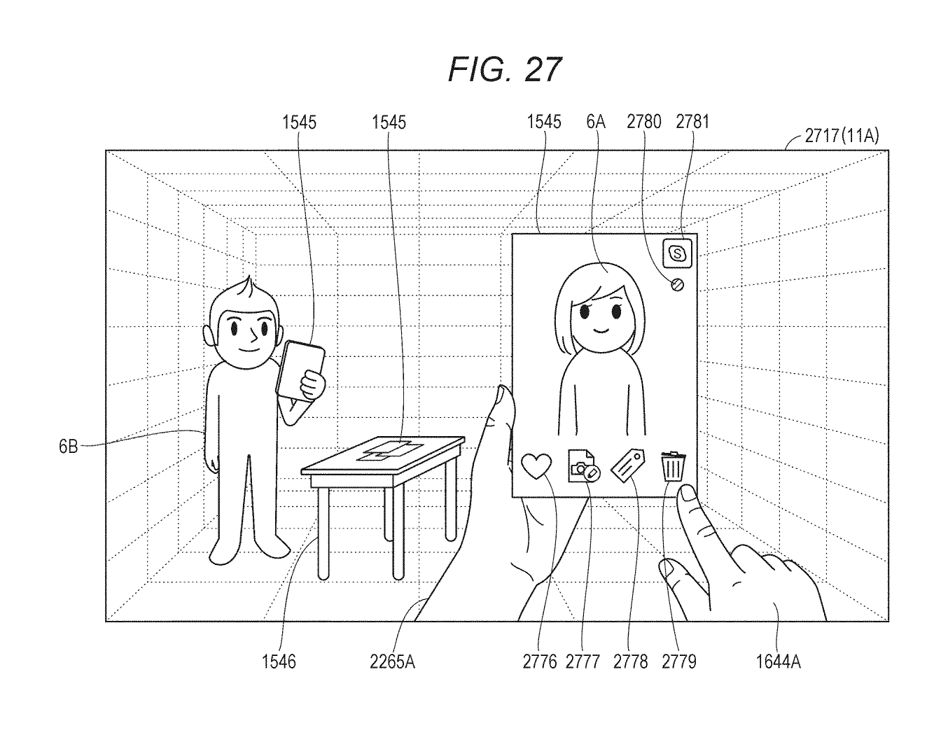

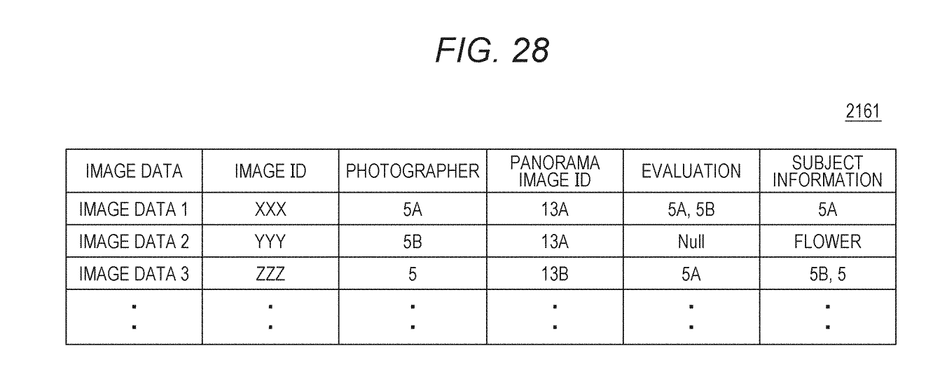

FIG. 27 is a diagram of processing on the photograph object 1545 or the photograph image represented by the photograph object 1545 according to at least one embodiment of this disclosure. A field-of-view image 2717 visually recognized by the user 5A includes a right hand object 1644A corresponding to the right hand of the avatar object 6A, a left hand object 2265A corresponding to the left hand of the avatar object 6A, an avatar object 6B, a plurality of photograph objects 1545, and a table object 1546.

More specifically, the left hand object 2265A is holding a photograph object 1545. The avatar object 6B is also holding another photograph object 1545. A plurality of photograph objects 1545 different from those photograph objects 1545 are arranged on the table object 1546 functioning as the accumulation place.

In this manner, the user 5A and the user 5B may promote communication by using the photograph object 1545 representing the generated photograph image as a topic of discussion.

In addition to the photograph image, the photograph object 1545 includes a plurality of icons 2776 to 2779. The icon 2776 receives positive evaluation processing by the user 5 regarding the photograph image represented by the photograph object 1545. The icon 2777 receives processing of editing the photograph image represented by the photograph object 1545. The icon 2778 receives processing of associating the information on a subject included in the photograph image represented by the photograph object 1545 with the photograph image. The icon 2779 receives processing of deleting the photograph object 1545 from the virtual space 11A. The processing to be executed by the processor 210A when each of those icons is selected by an operation object is now described.

(Processing of Receiving Evaluation Regarding Photograph Image)

When the user 5A likes the photograph image represented by the photograph object 1545, the user 5A presses the icon 2776 with an operation object (e.g., right hand object 1644A).

The processor 210A accesses the photograph image DB 1434A, and associates information (hereinafter also referred to as “evaluation information”) indicating that the icon 2776 has been pressed with the photograph image represented by the photograph object 1545. In other words, the processor 210A stores in the photograph image DB 1434A data indicating that the photograph image represented by the photograph object 1545 is liked by the user 5A.

(Processing of Editing Photograph Image)

When the user 5A wishes to edit the photograph image represented by the photograph object 1545, the user 5A presses the icon 2777 with an operation object.

The processor 210A displays, based on pressing of the icon 2777, an edit menu of the photograph image on the photograph object 1545. As an example, the edit menu includes size correction (e.g., trimming processing), color adjustment (e.g., monochrome processing), brightness adjustment (e.g., sharpness processing), comment insertion, graphic insertion, and the like. The user 5A uses the operation object to make a selection in the edit menu displayed on the photograph object 1545. The processor 210A performs processing of editing the photograph image in accordance with the selected editing menu.

(Processing of Associating Subject Information with Photograph Image)

When the user 5A wishes to associate information on the subject (hereinafter also referred to as “subject information”) with the photograph image represented by the photograph object 1545, the user 5A presses the icon 2778 with an operation object.

As an example, the processor 210A displays on the photograph object 1545, based on pressing of the icon 2778, a software keyboard and an input box for receiving input of subject information. The user 5A operates the software keyboard with an operation object, and inputs the subject information into the input box. In at least one aspect, the processor 210A processes a character string extracted from a sound signal corresponding to an utterance of the user as the subject information.

In the example of FIG. 27, the photograph image includes the avatar object 6A. In this case, the user 5A is able to input to the input box information on the user 5A corresponding to the avatar object 6A as subject information. Examples of the information on the user 5A include a user ID, a name of the user 5A, and a character name of the avatar object 6. In at least one aspect, the photograph image includes the avatar object 6B. In this case, the user 5A inputs to the input box information on the user 5B corresponding to the avatar object 6B as subject information.

The processor 210A accesses the photograph image DB 1434A, and associates the input subject information with the photograph image represented by the photograph object 1545.

In at least one aspect, the processor 210A extracts a character string from a sound signal output by the microphone 170A after the icon 2778 is pressed, and receives the subject information.

In at least one aspect, the processor 210A automatically acquires the subject information at the time of photograph image generation. More specifically, the processor 210A detects an object (e.g., avatar object) included in the photography range 1542 of the camera object 1541A at the time of photography. The processor 210A stores information identifying the object in the photograph image DB 1434A in association with the photograph image as the subject information. With this configuration, the user 5A is able to save the time and effort involved with inputting the subject information.

(Processing of Deleting Photograph Object)

When the user 5A wishes to delete the photograph object 1545, the user 5A presses the icon 2779 with an operation object.

The processor 210A deletes the photograph object 1545 from the virtual space 11A based on pressing of the icon 2779. In at least one aspect, the processor 210A accesses the photograph image DB 1434A based on the pressing of the icon 2779, and deletes the photograph image represented by the photograph object 1545.

[Photograph DB]

FIG. 28 is a table of an example of the data structure of the photograph DB 2161 stored by the server 600 according to at least one embodiment of this disclosure. The photograph DB 2161 includes image data, a photograph ID, a photographer (user ID), a panorama image ID, evaluation information, and subject information.

As described above, when a photograph image is generated, the computer 200A transmits image data representing the photograph image, the photograph ID, the user ID, and the panorama image ID to the server 600 (Step S2627 of FIG. 26). The processor 610 of the server 600 registers the received information in the photograph DB 2161.

When the icon 2776 is pressed, the processor 210A transmits the photograph ID of the photograph image represented by the photograph object 1545 and the user ID to the server 600 in association with each other. When those pieces of information are received, the processor 610 accesses the photograph DB 2161, and registers the received user ID as the evaluation information associated with the received photograph ID.

When input of the subject information is received, the processor 210A transmits the subject information and the photograph ID of the photograph image represented by the photograph object 1545 to the server 600 in association with each other. When those pieces of information are received, the processor 610 accesses the photograph DB 2161, and registers the received evaluation information in association with the photograph ID.

With the configuration described above, the administrator of the server 600 is able to grasp based on the photograph DB 2161 the subject the user likes. In at least one aspect, the server 600 distributes to the computer 200 an advertisement or the panorama image 13 estimated to be of interest to the user based on the subject that the user likes.

In at least one aspect, when the icon 2779 is pressed, the processor 210A transmits a deletion instruction indicating that the icon 2779 has been pressed and the photograph ID of the photograph image represented by the photograph object 1545 to the server 600 in association with each other. When those pieces of information are received, the processor 610 accesses the photograph DB 2161 and deletes the data (including photograph image) associated with the received photograph ID.

[Modification Example of Processing of Receiving Evaluation Regarding Photograph Image]

(Evaluation Processing Based on Line of Sight)

In the example of FIG. 27, the processor 210A is configured to receive an evaluation regarding the photograph image represented by the photograph object 1545 based on the pressing of the icon 2776. In at least one aspect, the processor 210A receives a positive evaluation regarding the photograph image represented by the photograph object 1545 based on the line of sight of the user 5A in the virtual space 11A.

The field-of-view image 2717 further includes a pointer object 2780. The processor 210A detects the line of sight of the user 5A in the real space based on the output signal of the eye-gaze sensor 140. The processor 210A also converts, based on the position and inclination of the virtual camera 14A in the virtual space 11A, the detected line of sight into an XYZ coordinate system defined by the virtual space 11A. The processor 210A arranges the pointer object 2780 at a position at which the line of sight of the user 5A in the virtual space 11A and an object collide with each other. More specifically, the pointer object 2780 represents the position at which the user 5A is directing his or her line of sight in the virtual space 11A.

In the example of FIG. 27, the pointer object 2780 is arranged on the photograph object 1545. This indicates that the line of sight of the user 5A in the virtual space 11A is directed at the photograph object 1545. When the processor 210A detects that the line of sight of the user 5A has been directed at the photograph object 1545 for a time determined in advance (e.g., five seconds), the processor 210A executes the processing based on the pressing of the icon 2776 described above. The reason why the processor 210A executes such processing is that when the user 5A is staring at the photograph object 1545 for a long time, there is a high possibility that the user 5A is interested in the photograph image represented by the photograph object 1545.

In at least one aspect, the processor 210A executes the processing based on the pressing of the icon 2776 when the photograph object 1545 and the operation object are touching for a period of time determined in advance.

(Evaluation Processing Based on Touching Plurality of Operation Objects)

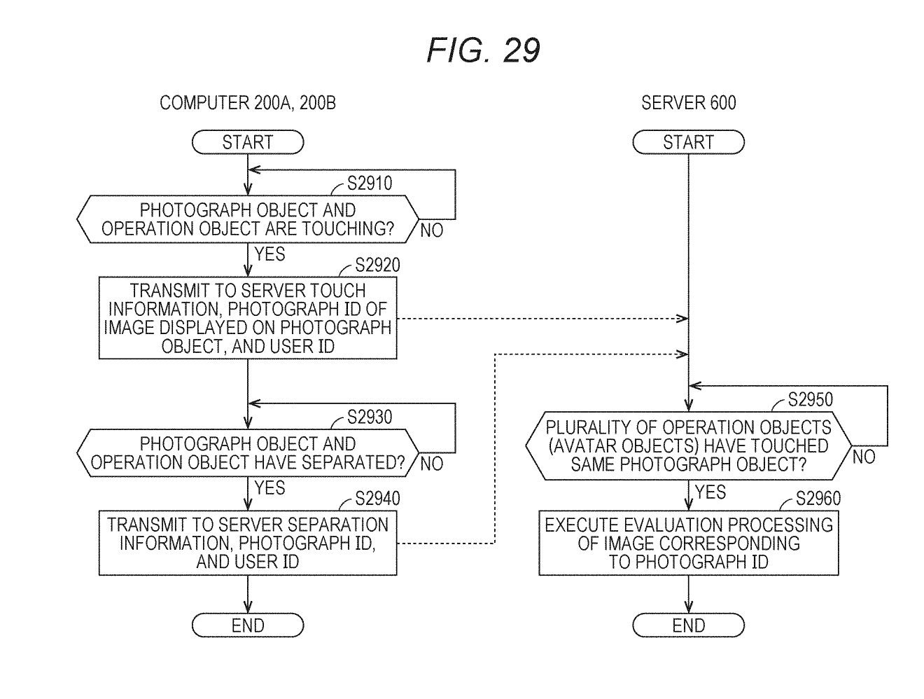

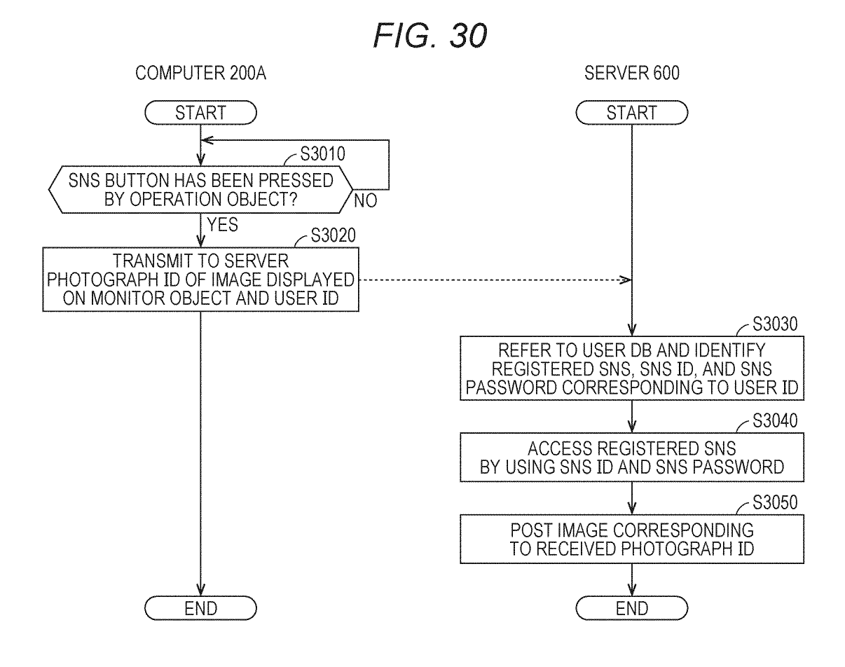

In at least one aspect, the server 600 executes the processing based on the pressing of the icon 2776 when the photograph object 1545 is touching a plurality of operation objects (hand parts of each of avatar objects 6A and 6B in example of FIG. 27). The reason why the processor 210A executes such processing is that under the above-mentioned condition, a plurality of users are communicating based on the photograph object 1545, and there is a high possibility that those plurality of users are interested in the photograph object 1545. This processing is now specifically described with reference to FIG. 29.

FIG. 29 is a flowchart of an example of processing in which the server 600 receives an evaluation regarding the photograph image according to at least one embodiment of this disclosure. In Step S2910, the processor 210A of the computer 200A determines whether the photograph object 1545 and the operation object corresponding to the user 5A are touching. When it is determined that the photograph object 1545 and the operation object are touching (YES in Step S2910), the processor 210A executes the processing of Step S2920. Otherwise (NO in Step S2910), the processor 210A waits until the photograph object 1545 and the operation object touch.

In Step S2920, the processor 210A transmits to the server 600 touch information indicating that the photograph object 1545 and the operation object are touching, the photograph ID of the photograph image represented by the photograph object 1545, and the user ID of the user 5A.

In Step S2930, the processor 210A determines whether the photograph object 1545 and the operation object have separated. When it is determined that the photograph object 1545 and the operation object have separated (YES in Step S2930), the processor 210A executes the processing of Step S2940. Otherwise (NO in Step S2930), the processor 210A waits until the photograph object 1545 and the operation object separate.

In Step S2940, the processor 210A transmits to the server 600 separation information indicating that the photograph object 1545 and the operation object have separated, the photograph ID, and the user ID.

The computer 200B sharing the virtual space with the computer 200A also executes the processing described in Step S2910 to Step S2940.

In Step S2950, the processor 610 of the server 600 determines whether the operation object corresponding to each of the users 5A and 190B has touched the photograph object 1545 based on the information received from each computer 200. More specifically, when the touch information is received, the processor 610 saves the user ID and the photograph ID associated with the touch information in a predetermined region of the storage 630. When the separation information is received, the processor 610 deletes the user ID and the photograph ID associated with the separation information from the predetermined region of the storage 630. When a plurality of user IDs are stored in the predetermined region of the storage 630 for one photograph ID, the processor 610 determines that a plurality of operation objects have touched the photograph object.

When it is determined that a plurality of operation objects have touched the photograph object (YES in Step S2950), the processor 610 executes the processing of Step S2960. Otherwise (NO in Step S2950), the processor 610 waits until a plurality of operation objects touch the photograph object.

In Step S2960, the processor 610 accesses the photograph DB 2161, and registers the user ID of each of the users 5A and 5B as the evaluation information corresponding to the received photograph ID.

[Processing of Posting to SNS]

Referring again to FIG. 27, the photograph object 1545 further includes an icon 2781. The icon 2781 receives an instruction to post the photograph image represented by the photograph object 1545 on an SNS registered in advance. The processing of posting the photograph image on the SNS is now described in detail with reference to FIG. 30.

FIG. 30 is a flowchart of processing in which the computer 200A and the server 600 work together to post a photograph image on an SNS according to at least one embodiment of this disclosure.

In Step S3010, the processor 210A of the computer 200A determines whether the icon 2781 (denoted as “SNS button” in FIG. 26) has been pressed by an operation object. When the icon 2781 has been pressed (YES in Step S3010), the processor 210A transmits the photograph ID of the photograph image represented by the photograph object 1545 and the user ID of the user 5A to the server 600 (Step S3020). Otherwise (NO in Step S3010), the processor 210A waits until the icon 2781 is pressed.

In Step S3030, the processor 610 of the server 600 refers to the user DB 2162, and obtains information required for registering the photograph image on the SNS.

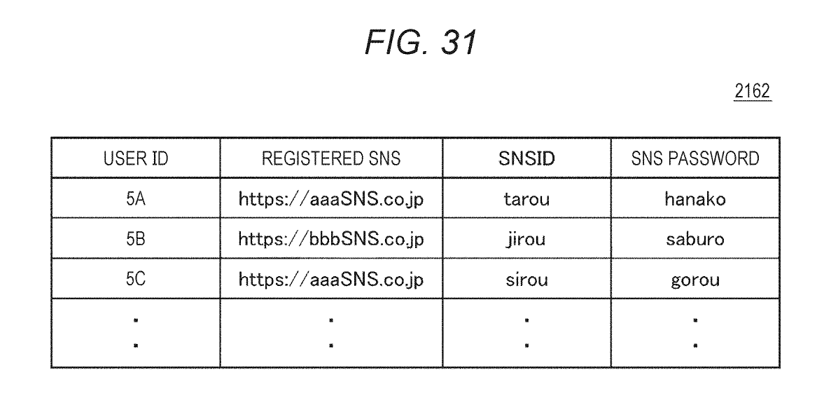

FIG. 31 is a table of an example of the data structure of the user DB 2162 according to at least one embodiment of this disclosure. The user DB 2162 includes the user ID, a registered SNS, an SNS ID, and an SNS password. The registered SNS is information (e.g., uniform resource locator (URL)) for accessing the SNS registered for each user. The SNS ID is information for identifying the user 5 in the registered SNS. The SNS password is information required for logging in to the registered SNS using the SNS ID. The registered SNS, the SNS ID, and the SNS password are registered in advance in the user DB 2162 by each user 5.

Referring again to FIG. 30, the processor 610 refers to the user DB 2162 to identify the registered SNS, SNS ID, and SNS password corresponding to the user ID received from the computer 200A (Step S3030).

In Step S3040, the processor 610 accesses the registered SNS by using the identified SNS ID and SNS password.

In Step S3050, the processor 610 accesses the photograph DB 2161, and posts (uploads) the photograph image (image data) corresponding to the received photograph ID on the registered SNS. In at least one aspect, the processor 610 associates the photograph image with the subject information corresponding to the received photograph ID, and posts the associated information on the registered SNS. With this configuration, when posting the photograph image on the registered SNS, the user 5A can save the time and effort involved with separately inputting the information on the subject included in the photograph image. In at least one aspect, the processor 610 associates the photograph image with information on the photographer corresponding to the received photograph ID, and posts the associated information on the registered SNS. With this configuration, the user 5A can save the time and effort involved with separately inputting the information on the photographer of the photograph image when posting the photograph image on the registered SNS.

With the configuration described above, in the virtual space 11A, the user 5A is able to easily post the generated photograph image on the SNS.

[Deletion Processing Based on Destructive Operation]

In the example of FIG. 27, the processor 210A deletes the photograph object 1545 from the virtual space 11A based on pressing of the icon 2779. In at least one aspect, the processor 210A deletes the photograph object 1545 from the virtual space 11A when an operation of destroying the photograph object 1545 is received.

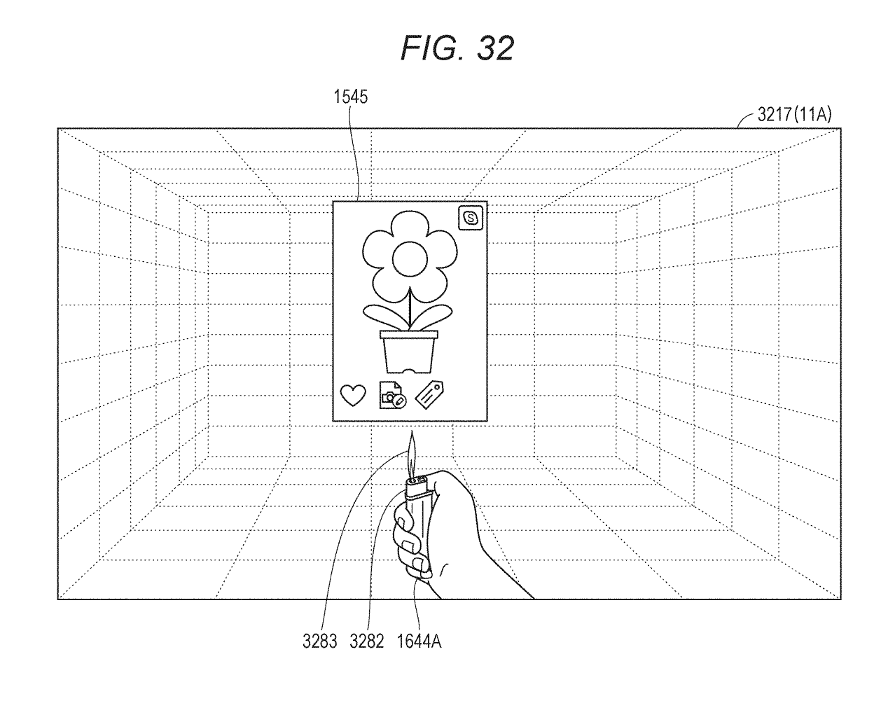

FIG. 32 is a diagram of processing of deleting the photograph object 1545 from the virtual space 11A providing a field-of-view image 3217 according to at least one embodiment of this disclosure. The field-of-view image 3217 includes a photograph object 1545 and a right hand object 1644A functioning as an operation object.

In the example of FIG. 32, the right hand object 1644A is holding a lighter object 3282. Further, a flame object 3283 is arranged adjacent to the lighter object 3282.

In at least one aspect, the user 5A operates the UI object 2266 with the left hand object 2265A under a state in which the right hand object 1644A is holding the lighter object 3282. As a result, the processor 210A arranges the flame object 3283 adjacently to the lighter object 3282.

The processor 210A deletes the photograph object 1545 from the virtual space 11A based on the flame object 3283 touching the photograph object 1545.

With the configuration described above, the user 5A is able to delete the photograph object 1545 from the virtual space 11A by an intuitive operation of destroying the photograph object 1545. As a result, the user 5A can maintain a sense of immersion in the virtual space 11A.

The operation of destroying the photograph object 1545 is not limited to the flame object 3283 touching the photograph object 1545. For example, the processor 210A determines that an operation of destroying the photograph object 1545 has been received when a motion of tearing the photograph object 1545 with the right hand object 1644A and the left hand object 2265A is detected, or when a motion of hitting the photograph object 1545 against another object (e.g., ground) at a speed equal to or higher than a speed determined in advance by an operation object is detected.

[Processing of Generating Spirit Photograph]

In at least one aspect, the processor 210A generates a spirit photograph. This is to enable the user 5A to promote communication to/from other users sharing the virtual space by using the spirit photograph as a topic of discussion.

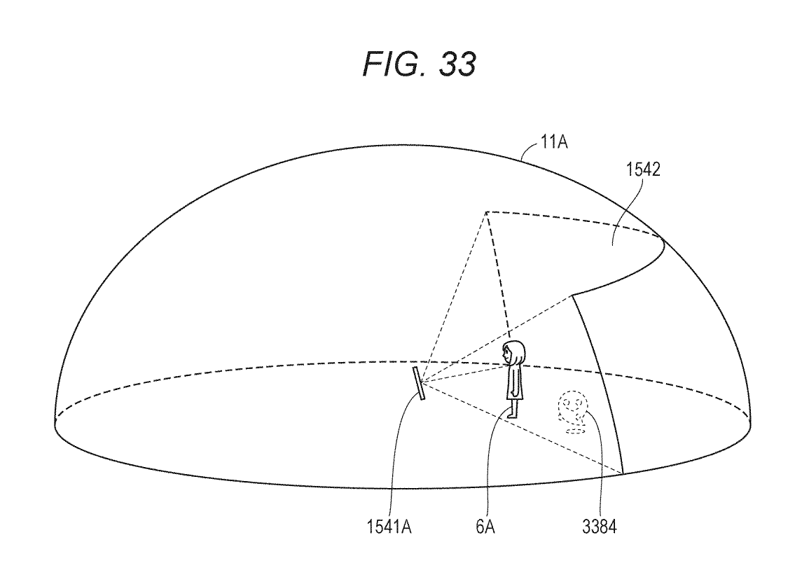

FIG. 33 is a diagram (part 1) of processing of generating a spirit photograph according to at least one embodiment of this disclosure. The virtual space 11A of FIG. 33 includes an avatar object 6A, a camera object 1541A, and a ghost object 3384.

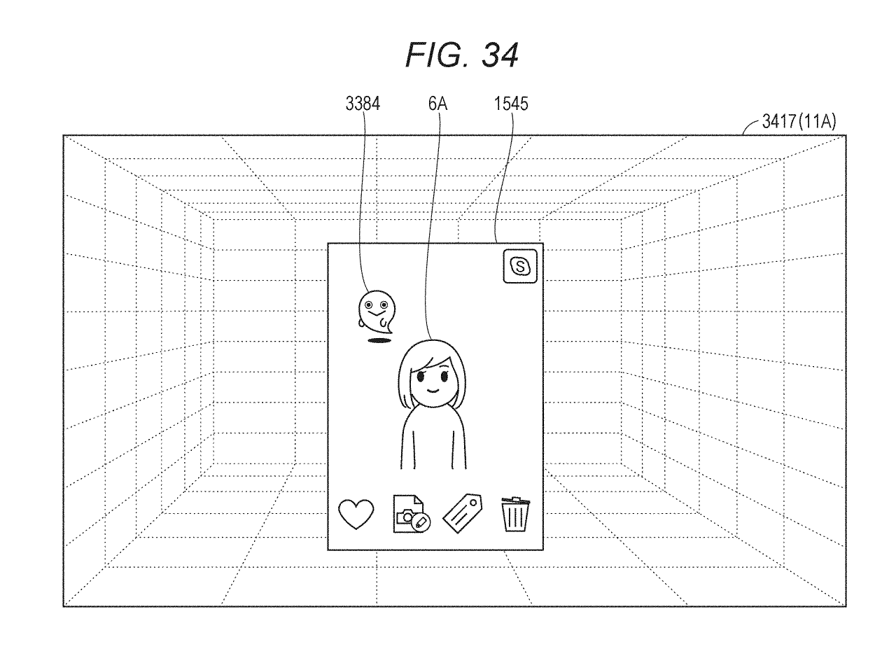

FIG. 34 is a diagram (part 2) of processing of generating a spirit photograph according to at least one embodiment of this disclosure. A field-of-view image 3417 in FIG. 34 includes a photograph object 1545. This photograph object 1545 represents the photograph image generated by the camera object 1541A under the state of FIG. 33. The photograph image includes a ghost object 3384.

When the ghost object 3384 is included in the photography range (field-of-view region 15A) of the virtual camera 14A, the processor 210A generates a field-of-view image not including the ghost object 3384. On the other hand, when the ghost object 3384 is included in the photography range 1542 of the camera object 1541A, the processor 210A generates a photograph image including the ghost object 3384.

As an example, the processor 210A arranges a transparent ghost object 3384 in the virtual space 11A. When the ghost object 3384 is included in the photography range 1542 of the camera object 1541A, the processor 210A visualizes the ghost object 3384 (e.g., decreases transparency of ghost object 3384) and generates a photograph image.

With the configuration described above, the user 5A is not able to directly visually recognize the ghost object 3384 arranged in the virtual space 11A, but is able to indirectly visually recognize the ghost object 3384 through the photograph image.

In at least one aspect, the ghost object 3384 is configured to not move in the virtual space 11A. In this case, the user 5A may enjoy searching for the place at which the ghost object 3384 is arranged. In at least one aspect, the ghost object 3384 is configured to move in the virtual space 11A. In this case, the user 5A can enjoy an unexpected spirit photograph.

[Processing of Generating Photograph Image of Avatar Object Having Different Display Mode]

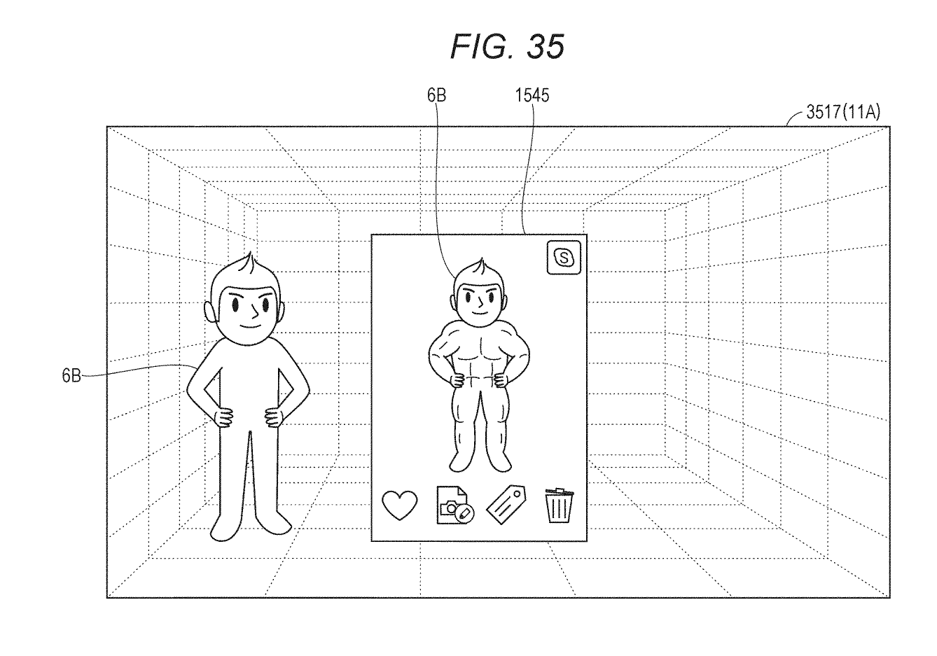

FIG. 35 is a diagram of processing of generating a photograph image including the avatar object 6B having a display mode different from that of the avatar object 6B arranged in the virtual space 11A according to at least one embodiment of this disclosure.

Referring to FIG. 35, a field-of-view image 3517 includes an avatar object 6B and a photograph object 1545 arranged in the virtual space 11A. The processor 210A receives a photography instruction from the user 5A under a state in which the avatar object 6B is included in the photography range 1542 of the camera object 1541A. In at least one aspect, the processor 210A generates a photograph image including an avatar object 6B having a display mode different from that of the avatar object 6B arranged in the virtual space 11A in accordance with the photography instruction.

In the example of FIG. 35, the avatar object 6B arranged in the virtual space 11A is slim. On the other hand, the avatar object 6B displayed on the photograph object 1545 has a good physique.

In at least one aspect, the processor 210A executes processing of changing the display mode of an avatar object included in the photograph image based on a setting received from the user 5A. In this case, the user 5A is able to generate a photograph image including the avatar object that he or she likes.

In at least one aspect, the processor 210A is configured to randomly execute processing of changing the display mode of an avatar object included in the photograph image. For example, the processor 210A generates a random number, and executes the processing when the generated random number satisfies a condition determined in advance. In this case, the user 5A is able to enjoy an unexpected photograph image.

The user 5A is able to promote communication to/from other users sharing the virtual space by using the photograph image including the avatar object having a changed display mode as a topic of discussion.

The processing of changing the display mode of an avatar object is not limited to processing of changing the physique of the avatar object. For example, the processing of changing the display mode of an avatar object includes processing of changing the clothing of the avatar object, and processing of changing the facial expression of the avatar object.

[Configurations]

The technical features disclosed above are summarized in the following manner.

(Configuration 1)

According to at least one embodiment of this disclosure, there is provided a program to be executed by a computer 200A to provide a virtual space 11A to an HMD 120A. This program causes the computer 200A to execute: defining the virtual space 11A (Step S2605); arranging a camera object 1541A having a photography function in the virtual space 11A (Step S2620); generating an image corresponding to a photography range of the camera object 1541A (Step S2627); arranging a photograph object 1545 representing the generated image in the virtual space 11A at a position determined in advance (Step S2630); and notifying a user 5 of the HMD 120A of the position at which the photograph object 1545 is arranged (Step S2635).

(Configuration 2)

In Configuration 1, the notifying includes moving the photograph object 1545 representing an image from the position of the camera object 1541A to the position determined in advance when the image is generated.

(Configuration 3)

In Configuration 1 or 2, the notifying includes arranging at a periphery of the position determined in advance an icon object 2574 indicating that a photograph object 1545 is arranged at the position determined in advance.

(Configuration 4)

In any one of Configurations 1 to 3, the notifying includes displaying on a display 130A of the HMD 120A a direction object 2368 representing a direction of the position determined in advance with respect to a position and line-of-sight direction of the user 5 in the virtual space 11A.

(Configuration 5)

The program according to any one of Configurations 1 to 4 includes causing the computer 200A to further execute: communicating to/from another computer 200B different from the computer 200A; arranging in the virtual space 11A another camera object 1541B different from the camera object 1541A for a user 5B of the another computer 200B to perform photography; and arranging at a position determined in advance another photograph object 1545B representing an image generated by photography of the another camera object 1541B (Step S2645). The notifying includes notifying a user 5A of the position at which the another photograph object 1545B is arranged when photography is performed by the another camera object 1541B (Step S2650).

(Configuration 6)

In Configuration 5, the notifying includes moving the another photograph object 1545B from the position of the another camera object 1541B to the position determined in advance when photography is performed by the another camera object 1541B (trajectory 1648 of FIG. 24).

(Configuration 7)

The program according to any one of Configurations 1 to 6 includes causing the computer 200A to further execute: arranging in the virtual space 11A an operation object configured to move in accordance with an operation of the user 5 of the computer 200A (Step S2615); and receiving input of processing on the photograph object 1545 or on the image represented by the photograph object 1545 based on an operation on the photograph object 1545 by the operation object (FIG. 27). The processing on the photograph object 1545 includes deleting the photograph object 1545 from the virtual space 11A. The processing on the image represented by the photograph object 1545 includes at least one of processing of editing the image represented by the photograph object 1545, processing of evaluating the image represented by the photograph object 1545, or processing of associating information on a subject included in the image represented by the photograph object 1545 with the image.

(Configuration 8)

The program according to Configuration 7 includes causing the computer 200A to further execute: communicating to/from another computer 200B different from the computer 200A; and arranging in the virtual space 11A an avatar object 6A corresponding to a user 5A of the computer 200A and an avatar object 6B corresponding to a user 5B of the another computer 200B. The generated image includes the avatar object 6A or 1500B. The information on the subject includes information on the user 5A corresponding to the avatar object 6A or the user 5B corresponding to the avatar object 6B included in the generated image. As a result, for example, the user 5A is able to easily determine whose avatar object is included in the image generated by the user 5B. The user 5A is able to easily search for an image including an avatar object of a specific person.

(Configuration 9)

In Configuration 7 or 8, the photograph object 1545 includes an icon. The receiving of the input of processing on the photograph object 1545 or on the image represented by the photograph object 1545 includes receiving processing based on an operation on the icon by an operation object.

(Configuration 10)

The program according to Configuration 9 includes causing the computer 200A to further execute arranging the avatar object 6A corresponding to the user 5A in the virtual space 11A (Step S2615). The operation object includes a hand of the avatar object 6. As a result, the user 5A feels as if his or her hand were present in the virtual space 11A, and can be more immersed in the virtual space 11A.

(Configuration 11)

The program according to any one of Configurations 1 to 6 includes causing the computer 200A to further execute: detecting a line of sight of the user 5A of the computer 200A in the virtual space 11A; and receiving an evaluation by the user 5 regarding the image represented by the photograph object 1545 based on the detected line of sight being directed at the photograph object 1545 for a period of time determined in advance (FIG. 27).

(Configuration 12)

The program according to any one of Configurations 1 to 11 includes causing the computer 200A to further execute: arranging in the virtual space 11A an operation object configured to move in accordance with an operation of the user 5A of the computer 200A (Step S2615); accessing a social networking service registered in advance (Step S3040) based on an operation of the operation object on the photograph object 1545 (Step S3010); and posting the image represented by the photograph object 1545 on the social networking service (Step S3050).

(Configuration 13)

The program according to any one of Configurations 7 to 10 includes causing the computer 200A to further execute deleting the photograph object 1545 from the virtual space 11A based on receiving an operation to delete the photograph object 1545. The operation of deleting the photograph object 1545 includes an operation of destroying the photograph object 1545 (FIG. 32).

(Configuration 14)

The program according to any one of Configurations 1 to 13 includes causing the computer 200A to further execute arranging in the virtual space 11A a transparent ghost object 3384 (FIG. 33). The generating of the image includes generating an image including a visualized ghost object 3384 when the ghost object 3384 is included in a photography range of the camera object 1541A (FIG. 34).

(Configuration 15)

The program according to any one of Configurations 1 to 14 includes causing the computer 200A to further execute: communicating to/from another computer 200B different from the computer 200A; and arranging in the virtual space 11A an avatar object 6B corresponding to a user 5B of the another computer 200B (Step S2615). The generating of the image includes generating an image including an avatar object 6B having a display mode different from a display mode of the avatar object 6B arranged in the virtual space 11A when the avatar object 6B is included in a photography range of the camera object 1541A.

(Configuration 16)

The program according to any one of Configurations 1 to 15 includes causing the computer 200A to further execute: transmitting the generated image to the server 600 (Step S2627); arranging an avatar object 6A corresponding to a user 5A of the computer 200A in the virtual space 11A (Step S2615); and transmitting to the server 600 information indicating that the avatar object 6A and the photograph object 1545A are touching (Step S2650). With this configuration, it is possible for the server 600 to detect that a plurality of avatar objects are simultaneously touching the same photograph object. When the server detects such a situation (YES in Step S2950), the server 600 receives evaluations by a plurality of users corresponding to the plurality of avatar objects regarding the image displayed on the photograph object (Step S2960).

In the embodiment described above, the description is given by exemplifying the virtual space (VR space) in which the user is immersed using an HMD. However, a see-through HMD may be adopted as the HMD. In this case, the user may be provided with a virtual experience in an augmented reality (AR) space or a mixed reality (MR) space through output of a field-of-view image that is a combination of the real space visually recognized by the user via the see-through HMD and a part of an image forming the virtual space. In this case, action may be exerted on a target object in the virtual space based on motion of a hand of the user instead of the operation object. Specifically, the processor may identify coordinate information on the position of the hand of the user in the real space, and define the position of the target object in the virtual space in connection with the coordinate information in the real space. With this, the processor can grasp the positional relationship between the hand of the user in the real space and the target object in the virtual space, and execute processing corresponding to, for example, the above-mentioned collision control between the hand of the user and the target object. As a result, it is possible to exert action on the target object based on motion of the hand of the user.

It is to be understood that the embodiments disclosed herein are merely examples in all aspects and in no way intended to limit this disclosure. The scope of this disclosure is defined by the appended claims and not by the above description, and it is intended that this disclosure encompasses all modifications made within the scope and spirit equivalent to those of the appended claims.

What is claimed is:

1. A method of providing a virtual space, the method comprising:
defining a virtual space,
wherein the virtual space comprises a first avatar object,
wherein the first avatar object is associated with a first user, and
wherein the first user is associated with a first head-mounted device;
determining a field of view of the first user based on a first virtual camera arranged in the virtual space;
displaying an image corresponding to the field of view of the first user on the first head-mounted device;
arranging a first photography object in a virtual space, wherein the first photography object comprises a user interface (UI) configured to receive from the first user a first operation of photographing in the virtual space;
identifying a photography range of the first photography object in response to receiving the first operation from the first user;
rendering an image corresponding to the identified photography range;
arranging, in response to the rendering, a first photograph object in the virtual space at a first position determined in advance, wherein the first photograph object comprises the rendered image; and
arranging a first guide object in the field of view of the first user in response to the arranging of the first photograph object at the first position in the virtual space, wherein the first guide object comprises information for notifying the first user of the first position in the virtual space.

2. The method according to claim 1,
wherein the virtual space comprises a second avatar object,
wherein the second avatar object is associated with a second user,
wherein the second user is associated with a second head-mounted device, and
wherein the method further comprises:
determining a field of view of the second user based on a second virtual camera arranged in the virtual space;
displaying an image corresponding to the field of view of the second user on the second head-mounted device;
arranging a second photography object in the virtual space, wherein the second photography object comprises a user interface (UI) configured to receive from the second user a second operation of photographing in the virtual space;
identifying a photography range of the second photography object in response to receiving the second operation from the second user;
rendering an image corresponding to the identified photography range;
arranging, in response to the rendering, a second photograph object in the virtual space at the first position, wherein the second photograph object comprises the rendered image; and
arranging the first guide object in the field of view of the first user in response to performing of photography by the second photography object in the virtual space.

3. The method according to claim 1, wherein the arranging of the first photograph object at the first position comprises:
generating the first photograph object at a second position in response to the rendering, wherein the second position is associated with a position of the first photography object at a time when the first operation is received;
identifying a trajectory along which the first photograph object moves from the second position to the first position; and
moving the first photograph object along the identified trajectory.

4. The method according to claim 3, further comprising:
generating a trajectory object having a shape of the trajectory in response to the identifying of the trajectory;
arranging the trajectory object in the virtual space based on the first position and the second position; and
deleting the trajectory object from the virtual space in response to a certain period of time elapsing since the arranging of the trajectory object in the virtual space and/or in response to the movement of the first photograph object from the second position to the first position.

5. The method according to claim 1,
wherein the first photograph object comprises:
a UI configured to receive from the first user a third operation of evaluating the rendered image;
a UI configured to receive from the first user a fourth operation of editing the rendered image; and
a UI configured to receive from the first user a fifth operation of associating the rendered image with the first user, and
wherein the method further comprises:
storing the image and the evaluating of the image in a memory in association with each other in response to receiving the third operation;
storing an editing result of the image in the memory in response to receiving the fourth operation; and
storing the image and identification information on the first user in the memory in association with each other in response to receiving the fifth operation.

6. The method according to claim 2,
wherein the second photograph object comprises:
a UI configured to receive from the first user and the second user a sixth operation of evaluating the rendered image;
a UI configured to receive from the first user and the second user a seventh operation of editing the rendered image; and
a UI configured to receive from the first user and the second user an eighth operation of associating the rendered image with the first user and the second user, and
wherein the method further comprises:
storing the image and the evaluating of the image in a memory in association with information identifying a user who has performed the evaluating in response to receiving the sixth operation;
storing an editing result of the image in the memory in response to receiving the seventh operation; and
storing the image, information identifying the first user, and information identifying the second user in the memory in association with each other in response to receiving the eighth operation.

7. The method according to claim 1, further comprising storing in a memory first information, which is information for the first user to log in to a social networking service (SNS), and second information indicating an access destination of the SNS,
wherein the first photograph object comprises a UI configured to receive from the first user a ninth operation for posting the rendered image on the SNS, and
wherein the method further comprises:
accessing the SNS based on the first information and the second information in response to receiving the ninth operation; and
posting the image on the SNS.

8. The method according to claim 1, further comprising:
storing in a memory information on an object to be arranged in the virtual space and information indicating whether the object is to be rendered by the first virtual camera;
arranging in the virtual space a first object inhibited from being rendered by the first virtual camera; and
rendering an image corresponding to the photography range of the first photography object with the first object as the object to be rendered in response to receiving the first operation from the first user.

9. The method according to claim 2, further comprising:
storing in a memory first shape data indicating a shape of the second avatar object and second shape data different from the first shape data;
arranging in the virtual space the second avatar object having the first shape data;
identifying whether the second avatar object is included in the photography range of the first photography object or the second photography object in response to receiving the first operation or the second operation; and
arranging, when the second avatar object is included in the photography range, the first photograph object or the second photograph object in the virtual space by rendering the second avatar object based on the second shape data, instead of based on the first shape data.

10. The method according to claim 1, further comprising:
detecting a tenth operation by the first user for moving the first avatar object in the virtual space;
moving the first avatar object in the virtual space in association with the tenth operation;
determining whether the first photograph object and the first avatar object are touching; and
storing an image of the first photograph object, evaluating of the image, and identification information on the first user in a memory in association with each other in response to the first photograph object touching the first avatar object.
